(19) United States
(12) Patent Application Publication
(10) Pub. No.: US 2026/0077729 A1
(43) Pub. Date: Mar. 19, 2026

(54) SYSTEM AND METHOD FOR MANAGING BATTERY POWER DRAIN

(71) Applicant: Volvo Car Corporation, Göteborg (SE)

(72) Inventors: Victor GUSTAFSON, Göteborg (SE); Henrik KLARS, Göteborg (SE); Michael ZACH, Göteborg (SE); Magnus AXELSSON, Göteborg (SE)

(73) Assignee: Volvo Car Corporation, Göteborg (SE)

(21) Appl. No.: 18/888,199

(22) Filed: Sep. 18, 2024

(51) Int. Cl. B60R 16/033; B60L 58/12; G07C 5/08; H01M 10/44; H01M 10/48; H02J 7/00

(52) U.S. Cl. CPC B60R 16/033; G07C 5/0808; G07C 5/0816; H01M 10/44; H01M 10/48; B60L 58/12; H01M 2220/20; H02J 7/82

(57) ABSTRACT

Embodiments relate to a system for managing battery power drain in vehicles. The system includes a wakeup monitoring module and a controller communicatively coupled to the wakeup monitoring module, wherein the controller is operable to: determine a first time period associated with a drain status of a battery in a vehicle, determine a second time period associated with an unused status of the vehicle, determine a third time period associated with a use status of the vehicle based on a transition of the vehicle from the unused status to the use status, and determine a wakeup cycle based on the first time period, the second time period, and the third time period, wherein the wakeup monitoring module is operable to monitor a plurality of operations associated with the vehicle based on the wakeup cycle.

### FIELD OF INVENTION

This disclosure relates to the field of vehicles. The disclosure is more particularly related to managing power drain in batteries in a vehicle.

### BACKGROUND

Most vehicles include batteries for their operation. The batteries get recharged when a vehicle is running. However, when the vehicle is idle or not in use, for example, if the vehicle is parked for a long period of time, the battery will slowly drain. Without re-charging, the battery can completely drain, thereby leaving an owner of the vehicle stranded when there is a need to use the vehicle.

Therefore, there is a need for a system and a method for managing battery power drain.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In an aspect the present invention relates to a system comprising: a wakeup monitoring module; and a controller communicatively coupled to the wakeup monitoring module, wherein the controller is operable to: determine a first time period associated with a drain status of a battery in a vehicle; determine a second time period associated with an unused status of the vehicle; determine a third time period associated with a use status of the vehicle based on a transition of the vehicle from the unused status to the use status; and determine a wakeup cycle based on the first time period, the second time period, and the third time period, wherein the wakeup monitoring module is operable to monitor a plurality of operations associated with the vehicle based on the wakeup cycle.

In another aspect the present disclosure relates to a method comprising: determining, by a controller, a first time period associated with a drain status of a battery in a vehicle; determining, by the controller, a second time period associated with an unused status of the vehicle; determining, by the controller, a third time period associated with a use status of the vehicle based on a transition of the vehicle from the unused status to the use status; determining, by the controller, a wakeup cycle based on the first time period, the second time period, and the third time period; and monitoring, by a wakeup monitoring module, a plurality of operations associated with the vehicle based on the wakeup cycle.

In yet another aspect the present disclosure relates to a non-transitory computer-readable medium having stored thereon instructions executable by a computer system to perform operations comprising: determining a first time period associated with a drain status of a battery in a vehicle; determining a second time period associated with an unused status of the vehicle; determining a third time period associated with a use status of the vehicle based on a transition of the vehicle from the unused status to the use status; determining a wakeup cycle based on the first time period, the second time period, and the third time period; and monitoring a plurality of operations associated with the vehicle based on the wakeup cycle.

### BRIEF DESCRIPTION OF THE FIGURES

These and other aspects of the present invention will now be described in more detail, with reference to the appended drawings showing exemplary embodiments of the present invention, in which:

FIG. 1 illustrates a block diagram of a system for managing battery power drain in a vehicle according to an embodiment.

FIG. 2A illustrates an internal view of a battery system in the vehicle according to an embodiment.

FIG. 2B shows a block diagram of electronic components of the vehicle according to an embodiment.

FIG. 3 illustrates a flowchart describing a method for managing battery power drain in the vehicle according to an embodiment.

FIG. 4 illustrates a flowchart describing a method for modifying a wakeup cycle associated with the vehicle according to an embodiment.

FIG. 5 illustrates a flowchart describing a method for reserving a battery charge level in the vehicle according to an embodiment.

FIG. 6 illustrates a network for a system and method of managing battery power drain in the vehicle according to an embodiment.

FIG. 7 illustrates a flowchart describing a method for modifying the wakeup cycle associated with the vehicle according to an embodiment.

FIG. 8 illustrates a flowchart describing a method for reserving a battery charge level in the vehicle according to an embodiment.

FIG. 9 illustrates a message flow diagram between the vehicle and a server according to an embodiment.

FIG. 10 shows an example block diagram for an Artificial Intelligence and Machine Learning (AI/ML) model used in a system managing battery power drain according to an embodiment.

FIG. 11A shows a structure of the neural network/machine learning model with a feedback loop according to an embodiment.

FIG. 11B shows a structure of the neural network/machine learning model with reinforcement learning according to an embodiment.

FIG. 12 shows a block diagram of the system of a vehicle for managing battery power drain according to an embodiment.

FIG. 13 shows a block diagram of the method executed by the non-transitory computer-readable medium for battery power drain managing system according to an embodiment.

FIG. 14A shows the block diagram of the cyber security module in view of the system and server according to an embodiment.

FIG. 14B shows an embodiment of the cyber security module according to an embodiment.

FIG. 14C shows another embodiment of the cyber security module according to an embodiment.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

Although the detailed description herein contains many specifics for the purpose of illustration, a person of ordinary skill in the art will appreciate that many variations and alterations to the details are considered to be included herein.

Accordingly, the embodiments herein are without any loss of generality to, and without imposing limitations upon, any claims set forth. The terminology used herein is for the purpose of describing particular embodiments only and is not limiting. Unless defined otherwise, all technical and scientific terms used herein have the same meaning as commonly understood by one with ordinary skill in the art to which this disclosure belongs. The following terms and phrases, unless otherwise indicated, shall be understood to have the following meanings.

As used herein, the articles “a” and “an” used herein refer to one or to more than one (i.e., to at least one) of the grammatical object of the article. By way of example, “an element” means one element or more than one element. Moreover, usage of articles “a” and “an” in the subject specification and annexed drawings construe to mean “one or more” unless specified otherwise or clear from context to mean a singular form.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items, and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent, or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

Digital electronic circuitry, or computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and / or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor will receive instructions and data from a read-only memory or a random-access memory or both. Elements of a computer can include a processor for performing instructions and one or more memory devices for storing instructions and data. A computer will also include, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disc Read-Only Memory (CD ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present invention may comprise or utilize a special purpose or general purpose computer including computer hardware. Embodiments within the scope of the present invention may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the invention can comprise at least two distinct kinds of computer-readable media: physical computer-readable storage media and transmission computer-readable media.

Although the present embodiments described herein are with reference to specific example embodiments it will be evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices.

The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the invention may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the invention. In a distributed system environment, program modules may be located in both local and remote memory storage devices.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein “Machine learning” refers to algorithms that give a computer the ability to learn without explicit programming, including algorithms that learn from and make predictions about data. Machine learning techniques include, but are not limited to, support vector machine, artificial neural network (ANN) (also referred to herein as a “neural net”), deep learning neural network, logistic regression, discriminant analysis, random forest, linear regression, rules-based machine learning, Naive Bayes, nearest neighbor, decision tree, decision tree learning, and hidden Markov, etc. For the purposes of clarity, part of a machine learning process can use algorithms such as linear regression or logistic regression. However, using linear regression or another algorithm as part of a machine learning process is distinct from performing a statistical analysis such as regression with a spreadsheet program. The machine learning process can continually learn and adjust the classifier as new data becomes available and does not rely on explicit or rules-based programming. The ANN may be featured with a feedback loop to adjust the system output dynamically as it learns from the new data as it becomes available. In machine learning, backpropagation and feedback loops are used to train the Artificial Intelligence/Machine Learning (AI/ML) model improving the model's accuracy and performance over time. Statistical modeling relies on finding relationships between variables (e.g., mathematical equations) to predict an outcome.

As used herein, the term “Data mining” is a process used to turn raw data into useful information. It is the process of analyzing large datasets to uncover hidden patterns, relationships, and insights that can be useful for decision-making and prediction.

As used herein, the term “Data acquisition” is the process of sampling signals that measure real world physical conditions and converting the resulting samples into digital numeric values that a computer manipulates. Data acquisition systems typically convert analog waveforms into digital values for processing. The components of data acquisition systems include sensors to convert physical parameters to electrical signals, signal conditioning circuitry to convert sensor signals into a form that can be converted to digital values, and analog-to-digital converters to convert conditioned sensor signals to digital values. Stand-alone data acquisition systems are often called data loggers.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses etc. are examples of vehicles. Further, the vehicle may include electric vehicles (EVs), hybrid electric vehicles (HEVs) such as, without limitations, full hybrid electric vehicles (FHEVs) and mild hybrid electric vehicles (MHEVs), and plug-in electric vehicles (PEVs).

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” or “communication network” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example communication protocol is a DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International.

The term “bidirectional communication” as used herein refers to an exchange of data between two components. In an example, the first component can be a vehicle and the second component can be an infrastructure that is enabled by a system of hardware, software, and firmware.

The term “alert” or “alert signal” refers to a communication to attract attention. An alert may include visual, tactile, audible alert, and a combination of these alerts to warn the user of the vehicle. These alerts allow receivers, such as drivers or occupants, the ability to react and respond quickly.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module”, is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. Driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users' applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’‘01’, ‘B’ is ‘02’, and so on. For example, a message like “HELLO” will be encrypted as “0805121215,” and this value will be transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash will also change significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

As used herein the term “monitoring” refers to systematic observation and assessment of a system, process, or environment in real-time or near real-time. It involves the regular collection, analysis, and interpretation of data using various sensors. Monitoring may be continuous or adaptive.

As used herein the term “prioritized monitoring” refers to monitoring a plurality of operations associated with the vehicle based on a priority level. For example, each of the monitoring operations is assigned a priority level based on their importance in the vehicle functioning. the operations having higher priority are monitored first or monitored more frequently compared to the operations having lesser or lower priority..

The term “vehicle system” or “system of a vehicle” as used herein refers to the vehicle comprising the system described in the current application. The system may be integrated and is a part of the vehicle, for example, a system executing a method on a processor storing instructions in a non-transitory memory of the computer system of the vehicle. The system may be external, but the instructions or method is executed through the vehicle, for example the method being in a cloud but is accessed and executed by the vehicle. The system may be designed for a specific purpose to carry out a certain function or task, for example, transmitting a specific message to a user device. The designed system comprising instructions may also be using existing systems present on the vehicle, for example, a communication system of the vehicle.

The term “battery” as used herein refers to a battery system in the vehicle, wherein the battery system may be used for starting the vehicle or may be used for operating the vehicle. The battery system may also be used to enable the vehicle to run.

The term “unused status” as used herein refers to the state of the vehicle when an engine of the vehicle is in an OFF condition, i.e., the vehicle is stationary.

The term “use status” as used herein refers to the state of vehicle when the engine of the vehicle is in an ON condition.

The term “hibernation mode” as used herein refers to a state of the vehicle or a vehicle mode when the vehicle is in a key OFF or non-running status or an idle condition or ignition OFF condition. When in the hibernation mode the vehicle is in a low power state.

The term “wakeup monitoring module” or “wakeup module” or “monitoring module” or “monitoring system” as used herein refers to any hardware or software controller overseeing the operation of various other modules/subsystems in the vehicle during the hibernation mode. The wakeup monitoring module monitors such as, without limitations, a battery charge level, door unlock/lock signal, environmental temperature, remote start, passive safety system, alarm system, and a tire pressure.

The term “wakeup cycle” as used herein refers to a frequency at which the wakeup monitoring module oversees the operation of various other modules/subsystems when the vehicle is in hibernation mode.

The term “user” as used herein refers to any individual who is a driver or an owner of the vehicle. Broadly it may encompass any individual having the possession of the vehicle.

The term “user profile,” as used herein refers to a set of personalized data associated with an individual. For example, a user profile may include information such as personal details, home address, office address, emergency contact details, calendar information such as meetings the user needs to attend, travel schedule, work schedule, etc. User profile is accessible to the user and the service provider of the registration system. Some of the user profile details may be optional like home address, office address, and some may be mandatory like contact number. User profile is protected using a cybersecurity module and encryption.

Vehicles, majorly used for commuting, require energy for their operation. A vehicle includes a power generation system comprising an alternator and a voltage converter for supplying an operational voltage to one or more of its components. In addition to the power generation system, the vehicle also includes a plurality of battery packs for its operation. The battery packs assist in starting the vehicle and a safe operation of the vehicle in the event of a fault in the power generation system. The battery packs, however, need to be recharged periodically to perform their functions. In general, the battery packs get recharged by the power generation system when the vehicle is in a running state, i.e., the vehicle is being used. However, when the vehicle is idle or not in use, for example, if the vehicle is parked for a long period of time, there will be no recharging and the battery packs start to drain slowly. During the idle condition, the vehicle enters a hibernation mode and a small amount of power from the battery pack will be used for checking or monitoring one or more essential systems in the vehicle. Therefore, a prolonged idle condition may lead to a complete drain of the battery packs leading to difficulties in starting the vehicle.
Business Problem: Prolonged parking of vehicles leads to battery power drain creating a problem for a user of the vehicle when the user wants to restart the vehicle.
Technical Problem: Most of the existing solutions provide a pre-determined wakeup cycle for monitoring the operations of the vehicle when the vehicle enters a hibernation mode. The pre-determined wakeup cycle is based on a set of pre-defined conditions. However, such solutions could not cater to the changes in the pre-defined conditions impacting the battery drain condition.
Business Solution: Managing power drain in a vehicle battery by determining a wakeup cycle based on pre-defined conditions and adjusting/adapting the same to cater the changes in the pre-defined conditions.
Technical solution: In one aspect, the present disclosure is directed towards managing the power drain in the vehicle batteries by adjusting the frequency of monitoring one or more conditions of the vehicle during the hibernation mode. In an embodiment, a vehicle system or a system associated with the vehicle may obtain one or more information such as a time at which the vehicle enters an idle condition, an initial battery charge level, i.e., a charge level associated with the batteries when the vehicle enters the idle condition, a time by when the vehicle may be next used, and a charge level required for an anticipated use of the vehicle, i.e., the time for which the vehicle will be used when started again or when the vehicle exits from the idle condition. Based on the one or more information the system may determine a time taken for the initial battery charge level to reach a zero charge level and a time duration of when the vehicle will be next used. The system may then determine an initial wakeup cycle for monitoring the one or more activities associated with the vehicle based on the determination. The system checks if the vehicle battery will completely drain before the vehicle is next used and adjusts the wakeup cycle based on the vehicle battery completely draining before the next use. Further, the system keeps checking the battery charge level and adjusts the wakeup cycle to reserve the charge level required when the vehicle is next used. The system also considers the temperature to adjust the wakeup cycle.

In an embodiment, upon adjusting the wakeup cycle, if the system determines a situation where there is not enough charge level required by the vehicle for its next use, the system sends an alert message to the user of the vehicle indicating a power level and a draining speed associated with the battery. The system may also provide the user an option to schedule a distress call prior to a time of restarting the vehicle from the idle condition or automatically schedule a recharge for the battery prior to the time of restarting.

In an aspect the present invention relates to a system comprising: a wakeup monitoring module; and a controller communicatively coupled to the wakeup monitoring module, wherein the controller is operable to: determine a first time period associated with a drain status of a battery in a vehicle; determine a second time period associated with an unused status of the vehicle; determine a third time period associated with a use status of the vehicle based on a transition of the vehicle from the unused status to the use status; and determine a wakeup cycle based on the first time period, the second time period, and the third time period, wherein the wakeup monitoring module is operable to monitor a plurality of operations associated with the vehicle based on the wakeup cycle.

In another aspect the present disclosure relates to a method comprising: determining, by a controller, a first time period associated with a drain status of a battery in a vehicle; determining, by the controller, a second time period associated with an unused status of the vehicle; determining, by the controller, a third time period associated with a use status of the vehicle based on a transition of the vehicle from the unused status to the use status; determining, by the controller, a wakeup cycle based on the first time period, the second time period, and the third time period; and monitoring, by a wakeup monitoring module, a plurality of operations associated with the vehicle based on the wakeup cycle.

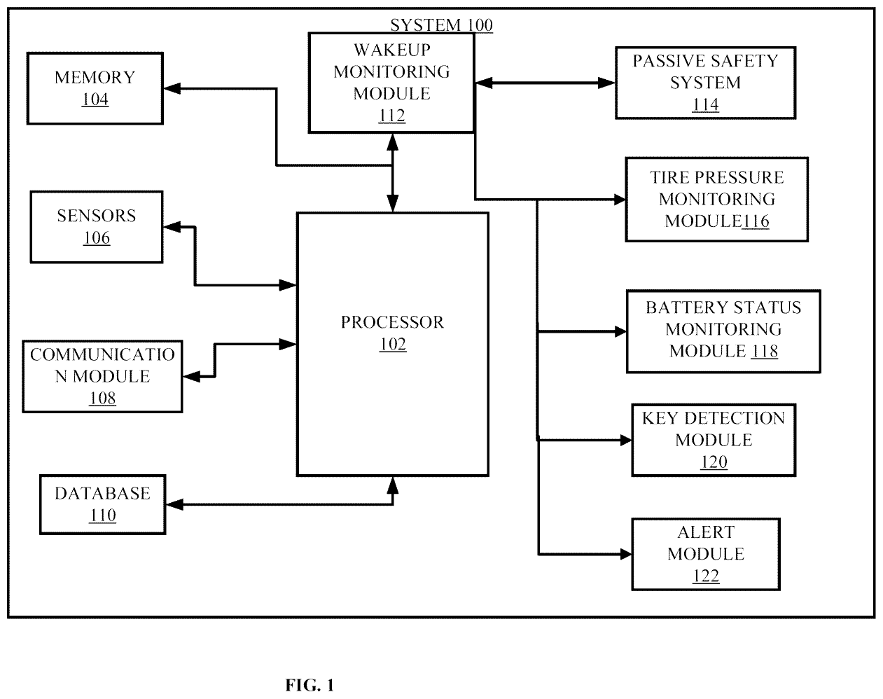

In yet another aspect the present disclosure relates to a non-transitory computer-readable medium having stored thereon instructions executable by a computer system to perform operations comprising: determining a first time period associated with a drain status of a battery in a vehicle; determining a second time period associated with an unused status of the vehicle; determining a third time period associated with a use status of the vehicle based on a transition of the vehicle from the unused status to the use status; determining a wakeup cycle based on the first time period, the second time period, and the third time period; and monitoring a plurality of operations associated with the vehicle based on the wakeup cycle.
Technical Result: Adaptive determination of wakeup cycle enables efficiently conserving a minimum battery power required by the vehicle for its operation when the vehicle is restarted after a prolonged idle/parked state.
Technical Details Specific to the Technical Solution: FIG. 1 illustrates a block diagram of a system for managing battery power drain in a vehicle according to an embodiment. System 100 comprises processor 102, memory 104, sensors 106, communication module 108, database 110, wakeup monitoring module 112, passive safety system 114, tire pressure monitoring module 116, battery status monitoring module 118, key detection module 120, and alert module 122.

Referring to FIG. 1, processor 102 may be a high-performance, multi-core CPU or system-on-chip (SoC) solution to process vast amounts of data from sensor 106 and wakeup monitoring module 112. In some embodiments, processor 102 processes data from sensor 106 and other inputs to make real-time decisions related to adjusting a wakeup cycle for monitoring one or more activities associated with the vehicle. Processor 102 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others might leverage Application-Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instruction. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, determine conditions associated with the vehicle and a user of the vehicle, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. Processor 102 interacts and exchanges data with one or more of the other components or modules of the system, for example, memory 104, sensors 106, communication module 108, database110, and wakeup monitoring module 112.

Referring to FIG. 1, memory 104 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a cloud-based memory. In another embodiment, the memory may be a local memory. In another embodiment, it may be a combination of local and cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

Referring to FIG. 1, sensor 106 may comprise various sensors such as a temperature sensor, ultrasonic sensors, LIDAR sensors, radar sensors, camera-based sensors, IR sensors, radio frequency identification (RFID) sensors, etc. Sensors, for example, including cameras, LIDARs, radars, and ultrasonic sensors enable autonomous vehicles to detect and recognize objects, obstacles, and pedestrians on the road to enable navigation of the autonomous vehicles. In some embodiments, communication module 108 facilitates communication between different modules within system 100, communication between the vehicle and other devices, other vehicles, and other infrastructure components.

Referring to FIG. 1, in some embodiments, database 110 may store data associated with various sensors 106, passive safety system 114, tire pressure monitoring module 116, battery status monitoring module 118, key detection module 120, and alert module 122. In some embodiments, database 110 may be locally present in the vehicle system 100 or may be present in a server associated with a manufacturer of the vehicle or in a cloud server. Processor 102 may fetch the data from database 110 to determine a wakeup cycle. Further, database 110 may also store the determined wakeup cycle.

Referring to FIG. 1, wakeup monitoring module 112 is coupled to processor 102 and monitors the activities of various modules such as, without limitations, passive safety system 114, tire pressure monitoring module 116, battery status monitoring module 118, key detection module 120, and alert module 122 when the vehicle is in the hibernation mode. In an embodiment, wakeup monitoring module 112 monitors the various modules based on a wakeup cycle, determined based on one or more information associated with the battery and a user of the vehicle. In some embodiments, passive safety system 114 includes components such as, without limitations, a seatbelt, airbags, a crumple zone, and a head rest for protecting people inside or outside the vehicle during a crash. During the hibernation mode, wakeup monitoring module 112 may monitor the passive safety system for any unintended operation for example, if the vehicle has been hit in a parked condition and if any of the passive safety systems have been activated due to the physical impact. In some embodiments, tire pressure monitoring module 116 may monitor the tire pressure in a predefined monitoring period and report the monitored tire pressure level to processor 102. In some embodiments, tire pressure monitoring module 116 may be activated based on the adjusted or modified wakeup cycle.

Referring to FIG. 1, in some embodiments, battery status monitoring module 118 may determine a charge level associated with the battery on every wakeup cycle. Battery status monitoring module 118 may then communicate the charge level to processor 102 for adjusting the wakeup cycle. Upon receiving the charge level during each wakeup cycle, processor 102 may determine if the charge level is sufficient for the next use of the vehicle after transitioning out of the idle condition; and, if there is an insufficient charge level, the processor proceeds to modify the wakeup cycle such that a required charge level is reserved. In some embodiments, key detection module 120 may monitor for any activity around the vehicle such as remote start of the vehicle, a door lock/unlock control signal, a keyless entry, or any deliberate opening of the vehicle door. Key detection module 120 may determine if the activity is authorized or not and may trigger an alert signal upon detecting an unauthorized activity. In some embodiments, alert module 122 may be activated when there is any alert message to be sent based on unauthorized entry or when the charge level in the battery is insufficient to start the vehicle.

In an embodiment, system 100 comprises a wakeup monitoring module 112; and a processor or controller 102 communicatively coupled to wakeup monitoring module 112, wherein the controller 102 is operable to: determine a first time period associated with a drain status of a battery in a vehicle; determine a second time period associated with an unused status of the vehicle; determine a third time period associated with a use status of the vehicle based on a transition of the vehicle from the unused status to the use status; and determine a wakeup cycle based on the first time period, the second time period, and the third time period, wherein wakeup monitoring module 112 is operable to monitor a plurality of operations associated with the vehicle based on the wakeup cycle. In some embodiments, monitoring a plurality of operations include monitoring one or more operations associated with the vehicle based on the wakeup cycle.

In some embodiments, the plurality of operations include monitoring activities associated with vehicle security systems, determining the drain status of the battery, detecting a keyless entry, detecting a remote start, monitoring an alarm system, fault diagnosis, monitoring operation of a telematics system, monitoring condition of passive safety systems, monitoring temperature associated with an environment of the vehicle, climate control operations, and monitoring tire pressure.

In some embodiments, the drain status of the battery comprises a decrease in an initial charge level of the battery and the first time period comprises a time taken for the initial charge level of the battery to reduce to a zero charge level.

In some embodiments, the initial charge level comprises a charge level of the battery based on the vehicle entering the unused status, wherein the unused status of the vehicle comprises the vehicle in an ignition OFF condition.

In some embodiments, the second time period comprises a time duration of the vehicle in the ignition OFF condition, wherein the transition of the vehicle from the unused status to the use status comprises the vehicle in an ignition ON condition.

In some embodiments, the third time period comprises a time duration associated with an activity of the vehicle based on the ignition ON condition.

In some embodiments, the controller is further operable to compare the first time period with the second time period; and modify the wakeup cycle to reserve a battery charge level for servicing an activity associated with the third time period based on the second time period greater than the first time period.

In some embodiments, the controller is further operable to: determine if the reserved battery charge level is able to service the activity associated with the third time period; and assign a priority level to the plurality of operations based on the reserved battery charge level failing to service the activity associated with the third time period.

In some embodiments, the controller is further operable to: determine a change in at least one monitored operation of the plurality of monitored operations; and modify the wakeup cycle based on the change in the at least one monitored operation.

In some embodiments, the controller is further operable to: determine an update to the drain status of the battery; update the first time period based on the updated drain status of the battery; and modify the wakeup cycle based on the updated first time period.

In some embodiments, the controller is further operable to: determine a change in the monitored temperature, and modify the wakeup cycle based on the change in the monitored temperature.

In some embodiments, the controller is further operable to perform at least one of: receive a manual input associated with the unused status and the use status of the vehicle; detect the unused status and the use status of the vehicle based on at least one of a schedule information, a calendar information, and a preset pattern associated with a user of the vehicle, determine an update associated with at least one of the unused status and the used status of the vehicle; determine a modification associated with at least one of the second time period, and the third time period based on an updated unused status and an updated use status, respectively; and modify the wakeup cycle based on at least one of a modified second time period and a modified third time period.

In some embodiments, the controller is further operable to: determine if a reserved battery charge level is able to service an activity associated with the modified third time period; and assign a priority level to the plurality of operations based on the reserved battery charge level failing to service the activity associated with the modified third time period. In some embodiments, assigning a priority level to the plurality of operations include assigning a priority level to one or more operations associated with the vehicle based on the wakeup cycle.

In some embodiments, the controller is further operable to: monitor the plurality of operations associated with the vehicle based on the assigned priority level and the modified wakeup cycle; determine if the reserved battery charge level is able to service the activity associated with the modified third time period; and generate an alert message to the user of the vehicle based on the reserved battery charge level failing to service the activity associated with the modified third time period.

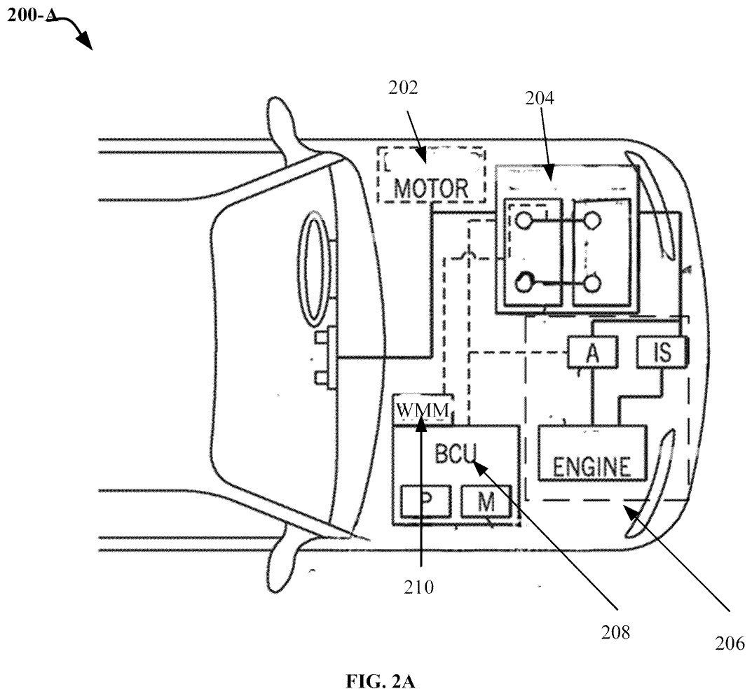

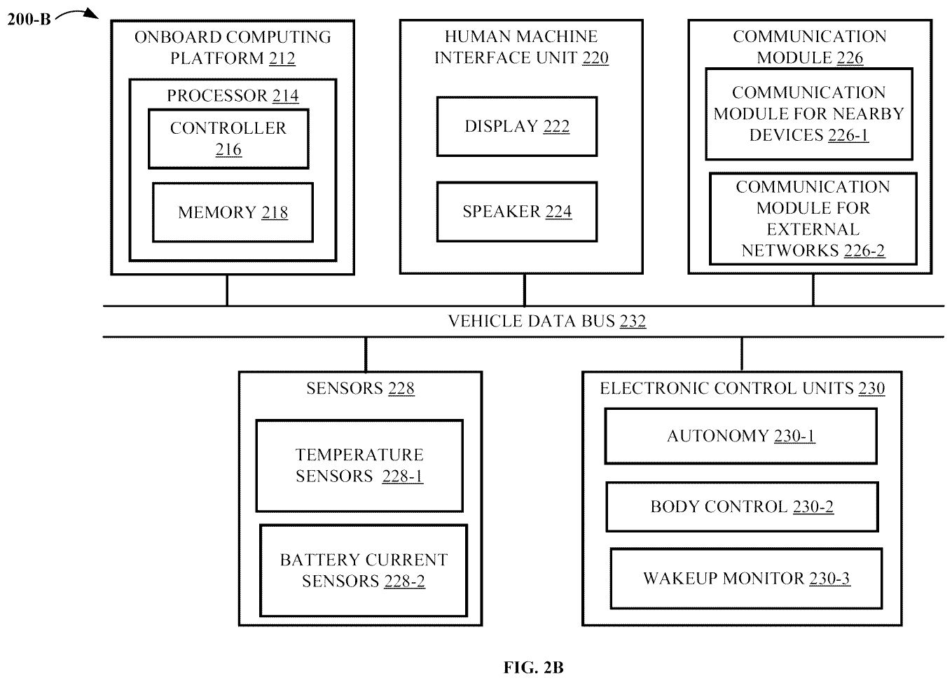

In some embodiments, the controller is further operable to: schedule, automatically, a battery recharge operation based on the reserved battery charge level failing to service the activity associated with the modified third time period. The operations of system 100 may be further elaborated with reference to FIGS. 2A and 2B discussed in detail below.

FIG. 2A illustrates an internal view of a power system in a vehicle according to an embodiment.

Referring to FIG. 2A, the vehicle 200-A comprising a motor 202, a storage unit 204, a power generation unit 206, a battery control unit 208, and a wakeup monitoring module 210 is shown. In some embodiments, the motor 202 may include such as, but not limited to, an electric motor. The motor 202 generates electrical energy by converting mechanical energy produced by the movement of the vehicle 200-A into electrical energy. The vehicle 200-A may also include a power generation unit 206 for generating the power required for the operation of the vehicle. In some embodiments, the power generation unit 206 may comprise an engine, an ignition system (IS) and an alternator (A). The engine may include, for example, an internal combustion engine, an electric motor engine, or a hybrid engine. The alternator (A) may generate power while the engine runs, i.e., the alternator may convert the mechanical energy produced by the rotation of the engine into electrical energy. The storage unit 204 stores/captures the generated electrical energy and outputs the electrical energy to power one or more components in the vehicle 200-A. In some embodiments, the storage unit 204 may include a plurality of battery modules and may store/capture the power generated by the motor 202 and the power generation unit 206. The plurality of battery modules may further comprise a plurality of battery cells. The battery modules may include, for example, lead acid batteries, lithium-ion batteries, sodium ion batteries, absorbent glass mat (AGM) batteries, gel cell batteries, solid state batteries, etc. In some embodiments, the plurality of battery modules includes one or more battery modules and the plurality of battery cells includes one or more battery cells.

Referring to FIG. 2A, the battery control unit 208 may perform one or more control and monitoring operations associated with the storage unit 204. In some embodiments, the battery control unit 208 refers to battery status monitoring module 118 shown in FIG. 1. The battery control unit 208 may regulate the amount of electrical energy stored and supplied by the plurality of battery modules, perform load balancing in the plurality of battery cells, control charging and discharging of the battery cells, determine a charge level associated with the plurality of battery modules, determine a drain status of battery modules, wherein the drain status may indicate a decrease in an initial charge level of the battery cells. In some embodiments, the initial charge level comprises a charge level of the battery based on the vehicle entering the unused status, wherein the unused status of the vehicle comprises the vehicle in an ignition OFF condition or idle condition or in a parked state. In some embodiments, the battery control unit 208 may include a processor (P) and a memory (M) to perform the monitoring and control operations. In some embodiments, the battery control unit 208 may capture the status associated with the battery modules/battery cells and communicate to the processors 102 as shown in FIG. 1 for the determination of drain status and also a first time period associated with the drain status of the battery.

Referring to FIG. 2A, the wakeup monitoring module (WMM) 210 may be connected to the battery control unit 208 to determine the battery status based on a wakeup cycle. In some embodiments, WMM 210 may receive an indication that the vehicle 200-A has entered a hibernation mode based on an unused status or a power OFF/key OFF/ignition OFF condition. The vehicle 200-A in the hibernation mode operates in a low power mode by shutting down most of the subsystems and activating a few essential subsystems based on the wakeup cycle. In some embodiments, WMM 210 may be associated with system 100 of FIG. 1 and may be connected to a few essential subsystems or status monitoring modules such as passive safety system 114, tire pressure monitoring module 116, battery status monitoring module 118, key detection module 120, and alert module 122. WMM 210 may send an activation signal or a “wakeup” signal to each of these modules during the wakeup cycle to monitor a plurality of operations associated with the vehicle. In some embodiments, the plurality of operations may include monitoring activities associated with vehicle security systems, determining the drain status of the battery, detecting a keyless entry, detecting a remote start, monitoring an alarm system, fault diagnosis, monitoring operation of a telematics system, monitoring condition of passive safety systems, monitoring temperature associated with an environment of the vehicle, climate control operations, and monitoring tire pressure. WMM may further report the status monitored to processor 102 to enable the processor to modify the frequency at which the essential subsystems are monitored to conserve a battery charge level required by the vehicle 200-A when the user of the vehicle restarts the vehicle from the ignition OFF state. In some embodiments, WMM 210 may send an initial wakeup signal to the battery control unit 208 to monitor a drain status associated with the battery modules and communicate the received drain status information to the process 102 to determine a first time period based on the drain status of the battery. Further, WMM 210 may send wakeup signals periodically based on the determined wakeup cycle to monitor an updated associated with the drain status of the battery and communicate the update to processor 102, wherein the processor may further determine an update associated with the drain status of the battery, update the first time period based on the updated drain status of the battery and modify the wakeup cycle based on the updated first time period.

FIG. 2B illustrates a block diagram of various electronic components of the vehicle according to an embodiment.

Referring to FIG. 2B, the vehicle comprising various electronic components such as onboard computing platform 212, human-machine interface (HMI) unit 220, communication module 226, sensors 228, electronic control units (ECUs) 230, and vehicle data bus 232, is shown. FIG. 2B illustrates an example architecture of some of the electronic components as shown in FIG. 1. Onboard computing platform 212 comprises processor 214 (also referred to as a microcontroller unit or a controller) and memory 218. In the illustrated example, processor 214 of onboard computing platform 212 is structured to comprise controller 216. In other examples, controller 216 is incorporated into another ECU with its own processor and memory. The processor 214 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). Memory 218 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, memory 218 comprises multiple kinds of memory, particularly volatile memory, and non-volatile memory. Memory 218 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of memory 218, the computer-readable medium, and/or within the processor 214 during execution of the instructions.

HMI unit 220 provides an interface between the vehicle and a user. HMI unit 220 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, display 222 (e.g., a heads-up display, a center console display such as a liquid crystal display (LCD), an organic light emitting diode (OLED) display, a flat panel display, a solid state display, etc.), and/or speaker 224. For example, display 222, speaker 224, and/or other input and output device(s) of HMI unit 220 are operable to emit an alert, such as an alert to request manual takeover to an operator (e.g., a driver) of the vehicle. Further, HMI unit 220 of the illustrated example comprises hardware (e.g., a processor or controller, memory, storage, etc.) and software (e.g., an operating system, etc.) for an infotainment system that is presented via display 222.

Sensors 228 are arranged in and/or around the vehicle to monitor the interior regions of the vehicle and/or an environment in which the vehicle is driving. One or more of sensors 228 may be mounted to measure various parameters around an exterior of the vehicle. Additionally, or alternatively, one or more of sensors 228 may be mounted inside a cabin of the vehicle or in a body of the vehicle (e.g., an engine compartment, wheel wells, etc.) to measure properties of the vehicle and/or interior sensing of the vehicle. For example, sensor 228 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type.

According to an embodiment of the system, the one or more sensors associated with the vehicle comprises one or more of a magnetic sensor, a proximity sensor, a load sensor, an electrical sensor, and a vision sensor, a motion sensor, temperature sensors, battery current sensors and a GPS sensor. Temperature sensors 228-1 may comprise, for example, coolant temperature sensor, air intake temperature sensor, manifold absolute pressure sensor, exhaust gas temperature sensor, oil temperature sensor, ambient air temperature sensor, etc., to detect different temperatures associated with the vehicle. Battery current sensor 228-2 may include, without limitations, a shunt sensor, a magnetic sensor. Data from battery current sensor 228-2 provides state of charge (SOC), state of health (SOH), and state of function (SOF) associated with the battery or storage unit 204 of FIG. 2A to enable determining the drain status of the battery. According to an embodiment of the system, the one or more sensors associated with the vehicle comprises camera-based sensors or a camera coupled with a computer vision system.

Referring to FIG. 2B, the ECUs 230 monitor and control the subsystems of the vehicle. For example, the ECUs 230 are discrete sets of electronics that comprise their own circuit(s) (e.g., integrated circuits, microprocessors, memory, storage, etc.) and firmware, sensors, actuators, and/or mounting hardware. The ECUs 230 communicate and exchange information via a vehicle data bus (e.g., the vehicle data bus 232). Additionally, the ECUs 230 may communicate properties (e.g., status of the ECUs, sensor readings, control state, error, and diagnostic codes, etc.) and/or receive requests from each other. For example, the vehicle may have many ECUs that are positioned in various locations around the vehicle and are communicatively coupled by the vehicle data bus 232.

In the illustrated example, the ECUs 230 comprise the autonomy unit 230-1, a body control module 230-2, and a wakeup monitor module 230-3. For example, the autonomy unit 230-1 is operable to perform autonomous and/or semi-autonomous driving maneuvers (e.g., defensive driving maneuvers) of the vehicle based upon, at least in part, instructions received from controller 216 and/or data collected by sensor 228 (e.g., object detection sensors). Further, the body control module 230-2 controls one or more subsystems throughout the vehicle, such as power windows, power locks, an immobilizer system, power mirrors, etc. For example, the body control module 230-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc. For example, the wakeup monitor module 230-3 monitors the status of a few of the essential subsystems such as, but not limited to, passive safety system 114, tire pressure monitoring module 116, battery status monitoring module 118, key detection module 120, and alert module 122 of FIG. 1, when the vehicle is in the hibernation mode. In some embodiments, the wakeup monitor module 230-3 monitors the status based on a wakeup cycle, wherein the wakeup cycle is based on the first time period, the second time period, and the third time period. The first time period associated with a drain status of the battery, the second time period associated with the unused status of the vehicle, and third time period associated with a use status of the vehicle based on a transition of the vehicle from the unused status to the use status.

Referring to FIG. 2B, the vehicle data bus 232 communicatively couples communication module 226, onboard computing platform 212, HMI unit 220, sensor 228, and the ECUs 230. In some examples, the vehicle data bus 232 comprises one or more data buses. The vehicle data bus 232 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

Referring to FIG. 2B, communication module 226 may comprise a near field communication module or communication module for nearby device 226-1 and a far field communication module or communication module for external network 226-2. The communication module for nearby devices 226-1 is operable to communicate with other nearby communication devices. In an example, communication module 226 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and / or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, the communication module for external networks 226-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V2X communication are being developed by the 3rd Generation Partnership Project. Further, communication module 226-2 is operable to communicate with external networks. For example, communication module 226-2 comprises hardware (e.g., processors, memory, storage, antenna, etc.) and software to control wired or wireless network interfaces. In the illustrated example, communication module 226-2 comprises one or more communication controllers for cellular networks (e.g., Global System for Mobile Communications (GSM), Universal Mobile Telecommunications System (UMTS), Long Term Evolution (LTE), Code Division Multiple Access (CDMA)), fifth generation 5G networks, Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 226-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

The autonomy unit 230-1 of the illustrated example is operable to perform autonomous and/or semi-autonomous driving maneuvers, such as defensive driving maneuvers, for the vehicle. For example, the autonomy unit 230-1 performs the autonomous and/or semi-autonomous driving maneuvers based on data collected by sensor 228. In some examples, the autonomy unit 230-1 is operable to operate a fully autonomous system, a park-assist system, an advanced driver-assistance system (ADAS), and/or other autonomous system(s) for the vehicle.

Further, in the illustrated example, controller (or control module) 216 is operable to monitor an ambient environment of the vehicle. For example, to enable the autonomy unit 230-1 to perform autonomous and/or semi-autonomous driving maneuvers, controller 216 collects data that is collected by sensors 228 of the vehicle. In some examples, controller 216 collects location-based data via communication module 226-1 and/or another module (e.g., a GPS receiver) to facilitate the autonomy unit 230-1 in performing autonomous and/or semi-autonomous driving maneuvers. Additionally, controller 216 collects data from (i) adjacent vehicle(s) via communication module 226-1 and V2V communication and/or (ii) roadside unit(s) via communication module 226-1 and V2I communication to further facilitate the autonomy unit 230-1 in performing autonomous and/or semi-autonomous driving maneuvers.

According to an embodiment, communication module 226 supports a communication protocol, wherein the communication protocol comprises at least one of a Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Diagnostics Over Internet Protocol (DoIP), On-Board Diagnostics (OBD) protocol, and a predefined protocol standard.

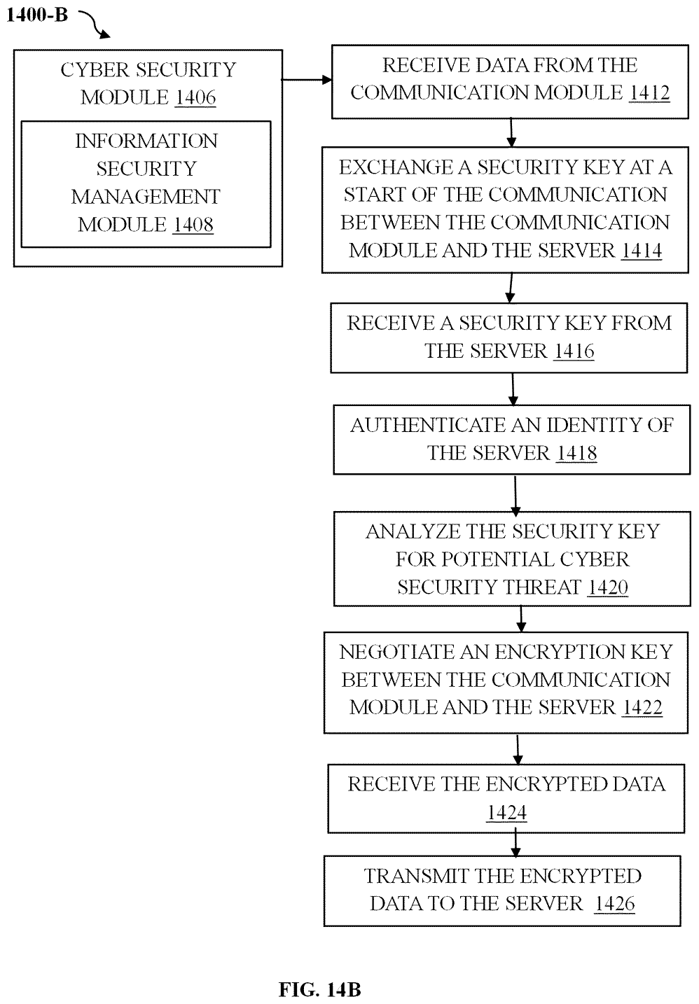

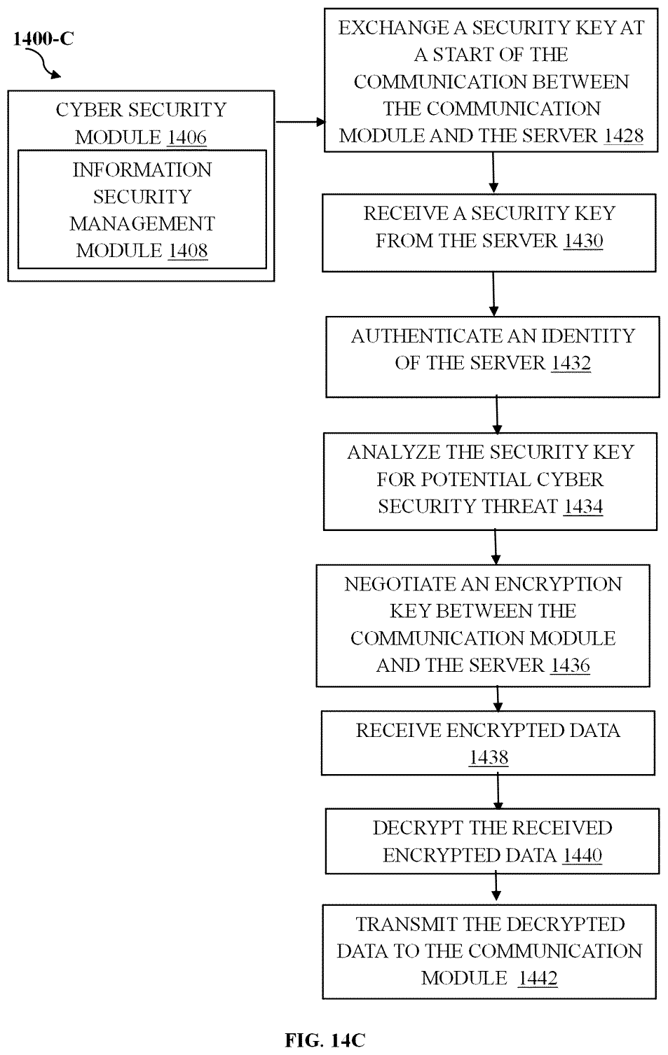

In an embodiment, communication module 226 may comprise a cyber security module 1406 (shown in FIG. 14A). In some embodiments, communication module 226 may communicate with cyber security module 1406 to perform secure communication with nearby devices and external networks. In one aspect, a secure communication management (SCMT) computer device for providing secure data connections is provided. The SCMT computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system. According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

In some embodiments, communication module 226 may receive a manual input associated with the unused status and the use status of the vehicle from a user of the vehicle. Further, communication module 226 may communicate with one or more devices associated with the user to detect the unused status and the use status of the vehicle based on at least one of a schedule information, a calendar information, and a preset pattern associated with a user of the vehicle. In some embodiments, communication module 226 may transmit an alert message to the user of the vehicle based on the reserved battery charge level failing to service the activity associated with the third time period or a modified third time period. In some embodiments, communication module 226 may transmit a message to third party service providers to schedule an automatic battery recharge operation based on the reserved battery charge level failing to service the activity associated with the third time period and the modified third time period.

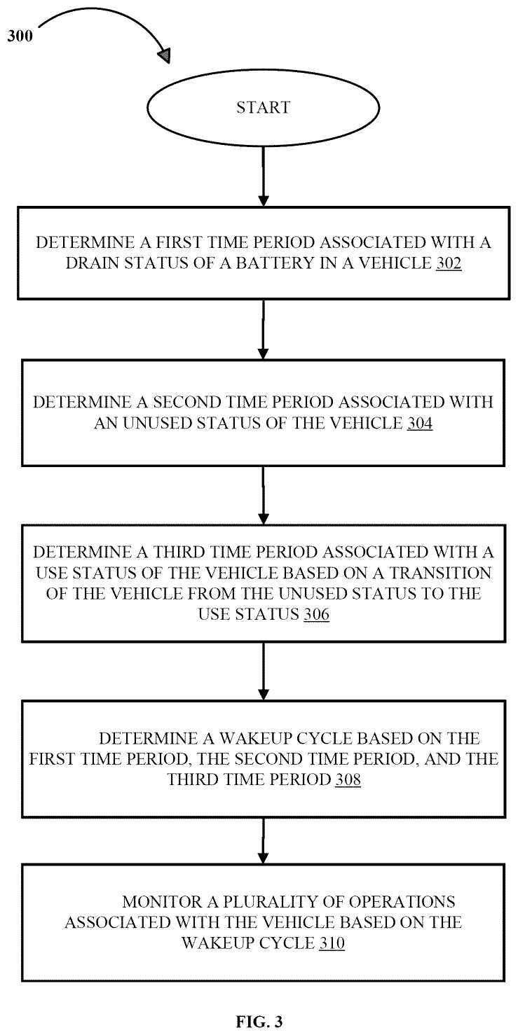

FIG. 3 illustrates a flowchart describing a method for managing battery power drain in the vehicle according to an embodiment.

In some embodiments, method 300 may be carried out by a controller using instructions stored in a non-transitory memory that, when executed, cause the controller to carry out method 300. In an embodiment, method 300 may be performed by system 100 as shown in FIG. 1.

Referring to FIG. 3, method 300 may, at step 302, determine a first time period associated with a drain status of a battery in a vehicle. In some embodiments, the drain status of the battery comprises a decrease in an initial charge level of the battery and the first time period comprises a time taken for the initial charge level of the battery to reduce to a zero charge level, wherein the initial charge level comprises a charge level of the battery based on the vehicle entering an unused status or hibernation mode or idle condition. Method 300 may at step 304, determine a second time period associated with the unused status of the vehicle, wherein the unused status of the vehicle comprises the vehicle in an ignition OFF condition and the second time period comprises a time duration of the vehicle in the ignition OFF condition. In an embodiment, the unused status includes the vehicle in the hibernation mode or an idle condition, i.e., the vehicle engine not running with the ignition OFF. For example, the vehicle may be in a parked condition and the second time period may include how long the vehicle is in the parked condition. Method 300 may further, at step 306, determine a third time period associated with a use status of the vehicle based on a transition of the vehicle from the unused status to the use status. In some embodiments, the transition of the vehicle from the unused status to the use status comprises the vehicle in an ignition ON condition and the third time period comprises a time duration associated with an activity of the vehicle based on the ignition ON condition. For example, the vehicle may be in the unused status or hibernation mode or the idle condition or the parked condition and may be turned ON (i.e., ignition ON) when the user of the vehicle requires to use the vehicle. Method 300 may, at step 308, determine a wakeup cycle based on the first time period, the second time period, and the third time period. Method 300 may, at step 310, monitor a plurality of operations associated with the vehicle based on the wakeup cycle. In some embodiments, wakeup monitoring module 112 is operable to monitor a plurality of operations associated with the vehicle based on the wakeup cycle. In some embodiments, the plurality of operations comprises at least one of: monitoring activities associated with vehicle security systems, determining the drain status of the battery, detecting a keyless entry, detecting a remote start, monitoring an alarm system, fault diagnosis, monitoring operation of a telematics system, monitoring condition of passive safety systems, monitoring temperature associated with an environment of the vehicle, climate control operations, and monitoring tire pressure.

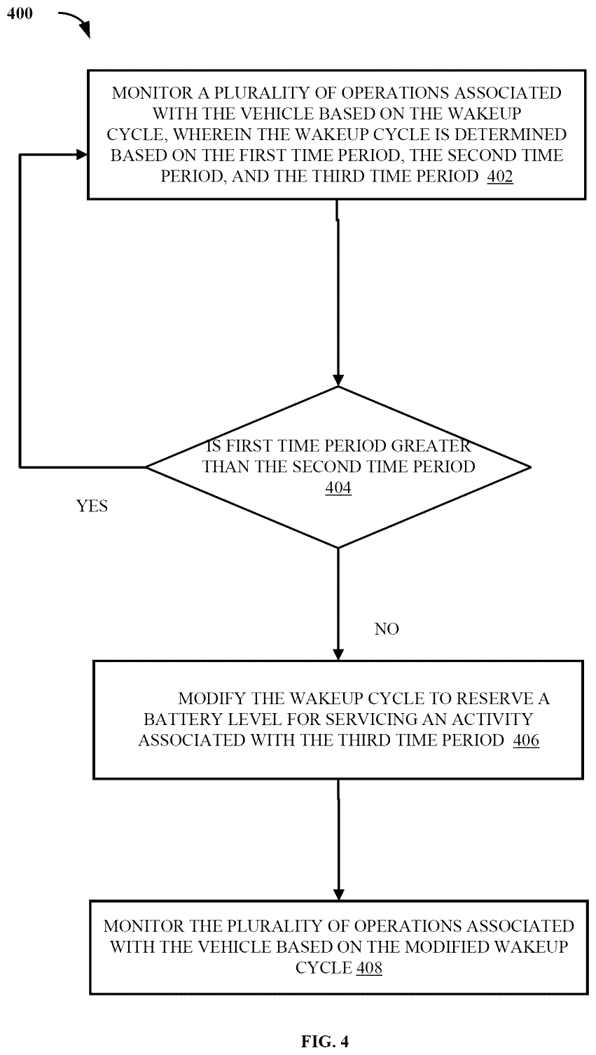

FIG. 4 illustrates a flowchart describing a method 400 for modifying a wakeup cycle associated with the vehicle according to an embodiment.

In some embodiments, method 400 may be carried out by a controller using instructions stored in a non-transitory memory that, when executed, cause the controller to carry out method 400. In an embodiment, method 400 may be performed by system 100 as shown in FIG. 1.

Referring to FIG. 4, method 400 may, at step 402, monitor a plurality of operations associated with the vehicle based on the wakeup cycle, wherein the wakeup cycle is determined based on the first time period, the second time period, and the third time period as discussed above in FIG. 3. Method 400 may, at step 404, compare the first time period with the second time period. If the first time period is less than the second time period, the method may, at step 406, modify the wakeup cycle to reserve a battery charge level required for servicing an activity associated with the third time period. At step 408, method 400 may further monitor the plurality of operations associated with the vehicle based on the modified wakeup cycle. On the other hand, if the first time period is greater than the second time period, method 400 may proceed with the step 402. For example, if the vehicle is parked for a long period of time, i.e., the vehicle in the unused status or the idle condition or the hibernation mode, a small amount of battery power will be used for monitoring one or more operations associated with the vehicle. Further, in the unused status there will be no recharging of the battery and the battery will drain slowly. If the time taken by the battery to drain completely is lesser than the parking time, the user may not be able to use the vehicle. Therefore, by modifying or adjusting the wakeup cycle, the system may conserve the energy required by the vehicle for use after the vehicle comes out of the idle condition. In some embodiments, monitoring the plurality of activities based on the modified wakeup cycle may still consume battery power and the system may then assign priorities to reserve the required battery charge level.

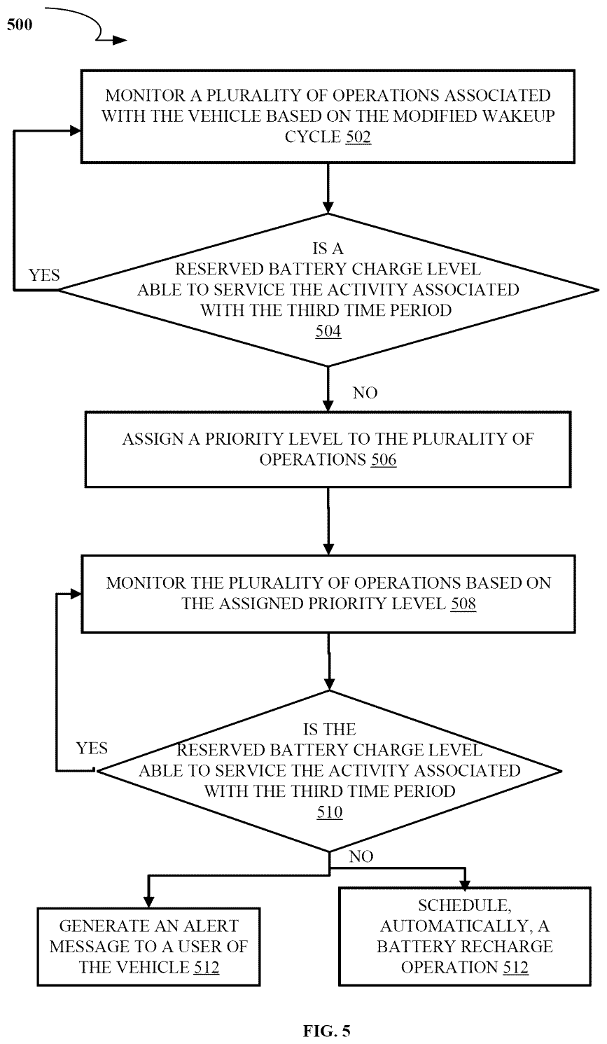

FIG. 5 illustrates a flowchart describing a method for reserving a battery charge level in the vehicle according to an embodiment.

In some embodiments, method 500 may be carried out by a controller using instructions stored in a non-transitory memory that, when executed, cause the controller to carry out method 500. In an embodiment, method 500 may be performed by system 100 as shown in FIG. 1.

Referring to FIG. 5, at step 502, method 500 may monitor a plurality of operations associated with the vehicle based on the modified wakeup cycle. At step 504, method 500 may determine if the reserved battery charge level will be able to service the activity associated with the third time period (i.e., if the reserved battery charge level is sufficient to service the activity associated with the third time period). If the reserved battery charge level is able to service the activity associated with the third time period, method 500 may include proceeding with step 502. On the other hand, if the reserved battery level is insufficient to service the activity associated with the third time period, method 500 may, at step 506, assign a priority level to the plurality of operations. Method 500 may, at step 508, monitor the plurality of operations based on the assigned priority level and may, at step 510, determine if the reserved battery charge level is able to service the activity associated with the third time period based on the prioritized monitoring. If the reserved battery charge level is able to service the activity associated with the third time period based on the prioritized monitoring, method 500 may include proceeding with step 508. On the other hand, if the reserved battery charge level is unable to service the activity associated with the third time period, method 500 may, at step 512, generate an alert message to the user of the vehicle that the battery level may drain before the next use or schedule. Automatically, a battery recharge operation call is placed to the nearest service station. In some embodiments, method 500 may generate the alert message to the user and schedule, automatically, the battery recharge operation. In some embodiments, the method 500 may schedule a distress signal to be sent out a few minutes prior to the arrival of the user so that the vehicle may be picked up/towed to a nearest service station for charging.

In some embodiments, system 100 may receive information related to the use and unused status of the vehicle from the user of the vehicle when the vehicle transitions from the used status to the unused status. Alternatively, the system may detect the unused status and the use status of the vehicle based on at least one of a schedule information, a calendar information, and a preset pattern associated with the user of the vehicle. When the vehicle transitions from the used status to the unused status, the vehicle may enter the hibernation mode. Upon entering the hibernation mode, the system may predict, based on the information received/detected, the battery drain status and adjust the wakeup cycle to conserve a power needed by the vehicle for performing an activity when the vehicle transitions out of the idle condition. For example, upon parking or transitioning from the ignition ON to ignition OFF state, the system may be provided with the information that the vehicle will remain parked for two days and the user of the vehicle may drive the vehicle for 1 hour after the two days, the system attempts to maintain charge that would allow the user to use the vehicle for an hour after two days. The system continuously monitors the health and remaining charge of the battery and may adjust the monitor frequency or wakeup cycle to reserve a battery charge level that may be needed for the vehicle to drive 1 hour after the two days of idle condition or unused status. However, due to external conditions (such as weather, modification in the plan of the user, or any other change), if the system determines that the system may not be able to reserve the required battery charge level for the anticipated one hour drive, the system may transmit a signal to alert the owner. The system may also schedule a distress signal to be sent out a few minutes prior to the arrival of the user so that the vehicle may be towed to a nearest service station for charging. Alternatively, the system may transmit a signal to the nearby service station to schedule a battery charge prior to the arrival of the user. The system may transmit information such as, but not limited to, the location of the vehicle, billing information, amount of charge needed, etc.

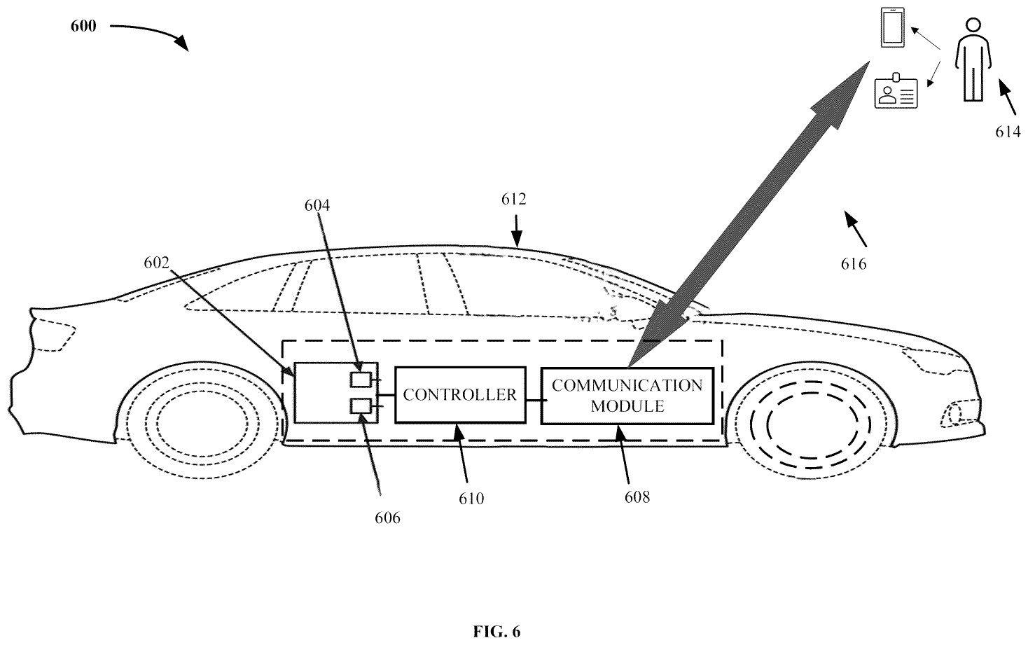

FIG. 6 illustrates network 600 for a system and method of managing battery power drain in the vehicle according to an embodiment.

Referring to FIG. 6, network 600 comprising vehicle 612, in communication with one or more user devices 614, through communication network 616, is shown. In some embodiments, vehicle 612 comprises controller 610 coupled to wakeup monitoring module 602, and communication module 608. Wakeup monitoring module 602 further comprises battery monitoring module 604 and temperature monitoring module 606. Wakeup monitoring module 602 and battery monitoring module 604 are similar to wakeup monitoring module 112 and battery status monitoring module 118 of FIG. 1 and are not discussed in detail here for the sake of brevity. In some embodiments, temperature monitoring module 606 may include one or more temperature sensors to detect the environmental temperature and a cabin temperature. In some embodiments, controller 610 may modify the wakeup cycle based on input information from user devices 614, the battery monitoring module 604, and temperature monitoring module 606. In some embodiments, controller 610 may receive an update information associated with the use and unused status of vehicle 612 based on the communication with user devices 614.

Referring to FIG. 6 in an embodiment, a connection is established between vehicle 612 and user device 614. User device 614 is detected by exchanging handshaking signals. Handshaking is the automated process for negotiation of setting up a communication channel 616 between entities. Controller 610 sends a start signal through communication module 608 in order to detect user device 614. If user device 614 receives the signal, controller 610 may receive an acknowledgement signal from user device 614. Upon receiving the acknowledgement signal, controller 610 establishes a secured connection with user device 614. Controller 610 may receive a signal at communication module 608 from user device 614. Controller 610 communicatively connects communication module 608 to user device 614. Controller 610 is operable to send and/or receive a message to and/or from user device 614. In some embodiments, controller 610 may receive information related to use status of the vehicle, the unused status of the vehicle, and an activity associated with the user of the vehicle when changing from the unused status to the use status. In one embodiment, the user may provide the information. In another embodiment, controller 610 may detect the information based on the communication with user device 614, wherein the user device may include a schedule information, a calendar information, or a preset pattern associated with the user. For example, the user may provide through user device 614 that the user will be out of station and the vehicle will be parked for three days and upon return the user needs to drive 40 miles to attend a meeting. Controller 610 may adapt or modify the wakeup cycle to reserve a charge needed by the vehicle to provide the 40 miles drive upon the return of the user.

In an embodiment, the communication between controller 610 and user device 614 is a bidirectional communication through communication network 616. Communication network 616 may include, for example, Global System for Mobile Communications (GSM), Universal Mobile Telecommunications System (UMTS), Long Term Evolution (LTE), Code Division Multiple Access (CDMA), fifth generation 5G networks, Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). Controller 610 through communication module 608 may transmit an alert message to the user device based on the complete drain of the battery. For example, controller 610 may generate an alert message stating, “The battery power is completely drained, and the vehicle might not be able to start when you return” and transmit the same to user device 614. Further, the controller 614 may also schedule a distress call based on the time of arrival of the user. In some embodiments, controller 610 may automatically schedule a battery recharge from a nearby service station.

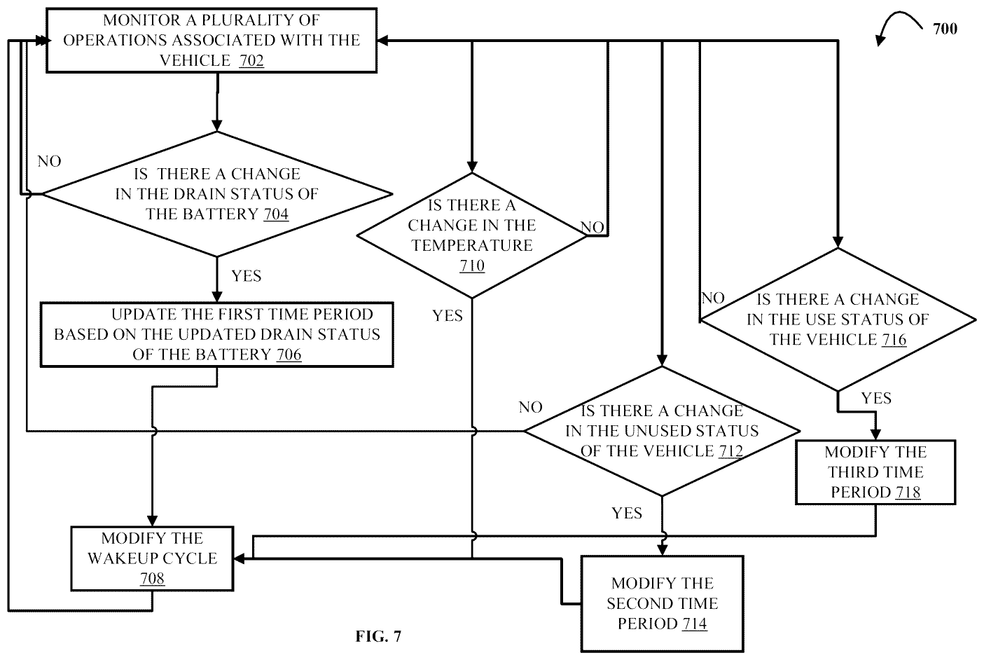

FIG. 7 illustrates a flowchart describing a method 700 for modifying the wakeup cycle associated with the vehicle according to an embodiment.

In some embodiments, method 700 may be carried out by a controller using instructions stored in a non-transitory memory that, when executed, cause the controller to carry out method 700. In an embodiment, method 700 may be performed by system 100 as shown in FIG. 1.

Referring to FIG. 7, method 700 may, at step 702, monitor a plurality of operations associated with the vehicle based on a wakeup cycle determined based on the first time period, the second time period, and the third time period. Method 700 may, at steps 704, 710, 712, and 716, determine whether there is a change in the drain status of the battery, a change in the temperature associated with the vehicle, a change in the unused status, and a change in the use status, respectively. If there is a change in the drain status of the battery, method 700 may, at step 706, update the first time period based on the updated drain status. Method 700 may further, at step 708, modify the wakeup cycle based on the updated first time period. If there is a change in the temperature, method 700 may further, at step 708, modify the wakeup cycle based on the temperature. For example, when the weather gets colder the battery drains faster and the wakeup cycle may be adjusted to reduce the number of times the vehicle operations are monitored. In some embodiments, apart from reducing the number of times the operation is performed, a priority may be assigned to the plurality of operations to reserve a charge level required for an activity to be performed when the vehicle changes from an unused status to the used status.

In an embodiment, method 700 may include determining a change in at least one monitored operation of the plurality of monitored operations, and modifying the wakeup cycle based on the change in the at least one monitored operation.

Referring to FIG. 7, if there is any change in the unused status, method 700 may at step 714 modify the second time period based on the updated unused status. Method 700 may then at step 708, modify the wakeup cycle based on the modified second time period. For example, if the user extends his/her trip, then the idle time of the vehicle gets increased and the frequency of monitoring the vehicle operations gets reduced. On the other hand, if the user shortens his/her trip, the idle time for the vehicle may be decreased and the frequency of monitoring the vehicle operations may be increased.

Referring to FIG. 7, if there is any change in the use status of the vehicle, method 700 may, at step 718, modify the third time period based on the updated use status. Method 700 may then, at step 708, modify the wakeup cycle based on the modified third time period. In some embodiments, modifications related to the use and unused status of the vehicle may be received from the user of the vehicle through the user device. Alternatively, the modifications may be detected by the system based on any modification associated with at least one of a schedule information, a calendar information, and a preset pattern associated with the user of the vehicle. For example, if the user changes his plan after return, and if the vehicle is anticipated to travel for 45 miles compared to an earlier plan of 30 miles, use time of the vehicle gets increased and the frequency of monitoring the vehicle operations gets reduced to reserve a charge required for the 45 miles travel. On the other hand, if there is no change in the drain status of the battery, the temperature associated with the vehicle, the unused status, and the use status, method 700 may include proceeding with the step 702.

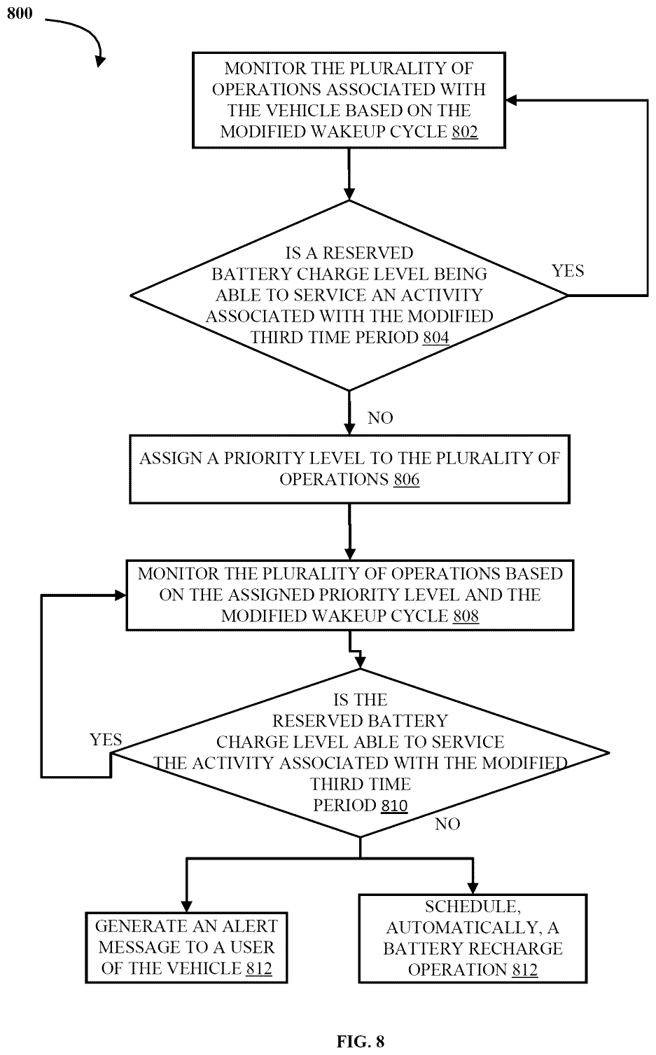

FIG. 8 illustrates a flowchart describing a method for reserving a battery charge level in the vehicle according to an embodiment.

In some embodiments, method 800 may be carried out by a controller using instructions stored in a non-transitory memory that, when executed, cause the controller to carry out method 800. In an embodiment, method 800 may be performed by system 100 as shown in FIG. 1.

Referring to FIG. 8, method 800 may, at step 802, monitor a plurality of operations associated with the vehicle based on the modified wakeup cycle. Method 800 may at step 804, determine if the reserved battery charge level is able to service the activity associated with the modified third time period (i.e., if the reserved battery charge level is sufficient to service the activity associated with the modified third time period). If the reserved battery charge level is insufficient to service the activity associated with the modified third time period, method 800 may include proceeding with step 802. On the other hand, if the reserved battery level is insufficient to service the activity associated with the modified third time period, method 800 may at step 806 assign a priority level to the plurality of operations. Method 800 may at step 808 monitor the plurality of operations based on the assigned priority level and may at step 810, determine if the reserved battery charge level is able to service the activity associated with the modified third time period based on the prioritized monitoring. If the reserved battery charge level is able to service the activity associated with the third time period based on the prioritized monitoring/the assigned priority level, method 800 may include proceeding with the step 808. On the other hand, if the reserved battery charge level is unable to service the activity associated with the modified third time period, method 800 may at step 812, generate an alert message to the user of the vehicle that the battery level is very low and may drain for the next use or schedule, and, automatically, place a call to the nearest service station for a battery recharge operation. In some embodiments, method 800 may generate the alert message to the user and schedule, automatically, the battery recharge operation. In some embodiments, the method 500 may schedule a distress signal to be sent out a few minutes prior to the arrival of the user so that the vehicle may be picked up/towed to a nearest service station for charging.

In some embodiments, a distress signal may be scheduled to be sent out a few minutes prior to the arrival of the user so that the vehicle may be towed to the nearest service station for charging.

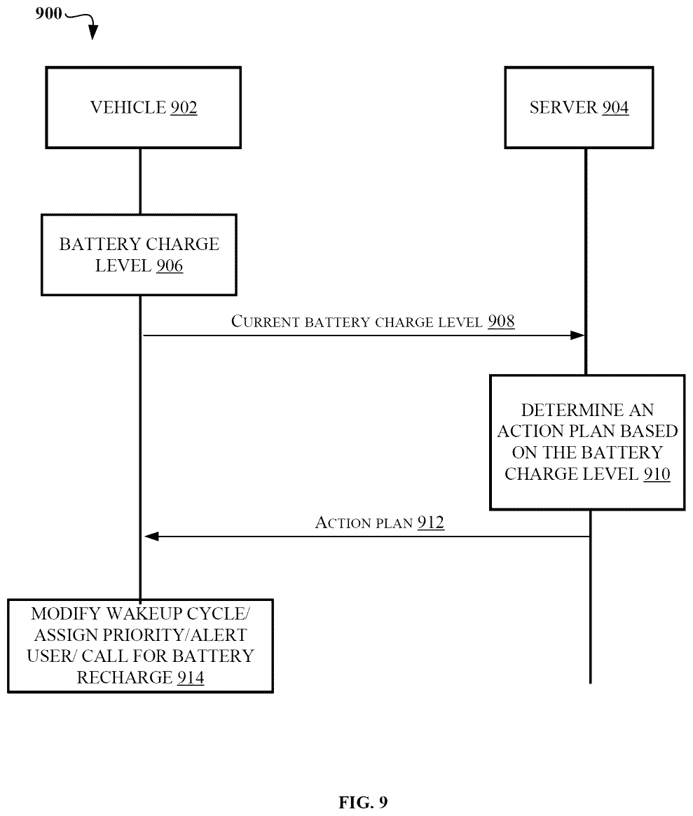

FIG. 9 illustrates message flow diagram 900 between the vehicle and a server according to an embodiment.

Referring to FIG. 9, a vehicle 902 in communication with a server 904 is shown. In some embodiments, vehicle 902 may send information for determining the wakeup cycle to server 904, and server 904 may process the received information to determine an action plan to be performed by the vehicle. In some embodiments, vehicle 902 may determine a battery charge level 906 and send current battery charge level message 908 to server 904. Vehicle 902 may also include information associated with the use and unused statuses of vehicle 902 in current battery charge level message 908. Server 904 may process the received current battery charge level and determine action plan 910 based on the received current battery charge level. Server 904 further communicates action plan message 912 to vehicle 902, wherein action plan message 912 may instruct vehicle 902 at step 914 to perform at least one of modifying the wakeup cycle, assigning a priority level to the plurality of operations monitored, generate an alert, or schedule a call.

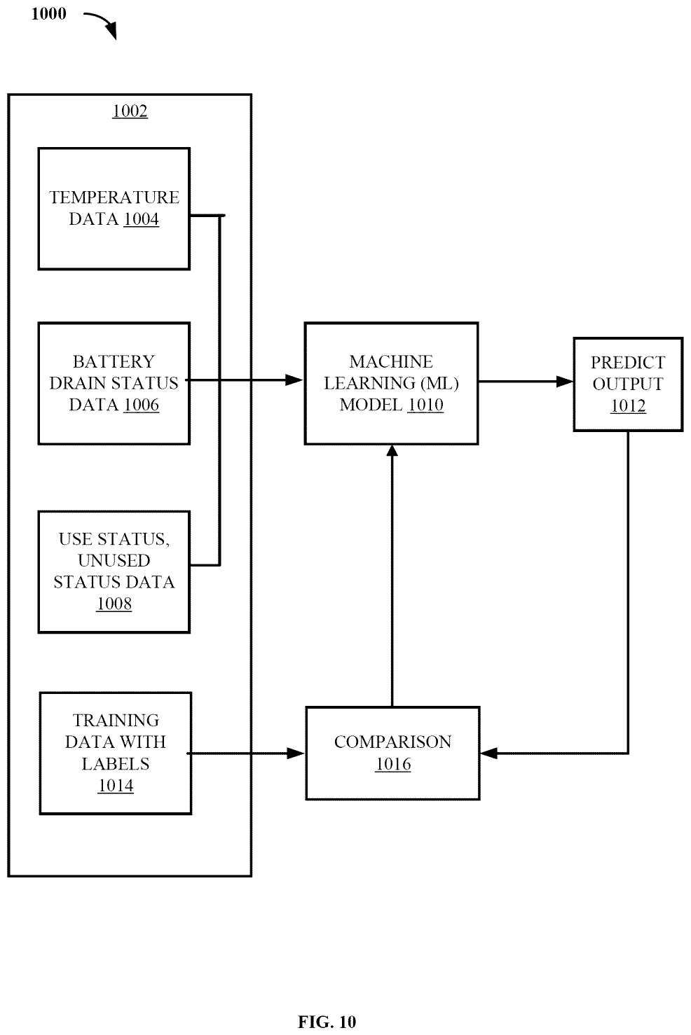

FIG. 10 shows an example block diagram 1000 for an Artificial Intelligence and Machine Learning (AI/ML) model used in a system managing battery power drain according to an embodiment.

Referring to FIG. 10, machine learning model 1002 may take as input temperature information 1004 (i.e., any data associated with temperature sensors in the vehicle), battery status information 1006, use status and unused status of the vehicle 1008 from the user/user device and learn to identify features within the data that are predictive of a time period associated with the battery drain status, a charge level for servicing an activity when the vehicle transitions from an unused or idle condition to a use status or an ignition ON condition, and wakeup cycle estimations. Training data 1014 sample may comprise, for example, a time duration for which a vehicle will be in the hibernation mode, battery power required for monitoring various operations of the vehicle, a charge level required by the vehicle for its running, effect of temperature on the battery power, battery age information, etc. The training data along with a current battery charge level may be transmitted to the cloud for determining to modify the wakeup cycle. The systems and methods of the present disclosure may also provide data analytics information that may be used later to improve the prediction accuracy of the battery drain time and the estimation accuracy of the wakeup cycles.

In an embodiment, during training, machine learning model 1010 may process training data sample 1002 (e.g., temperature information 1004, battery status 1006, use status and unused status 1008), and, based on the current parameters of machine learning model 1010, predict output 1012 which may be an estimation of the wakeup cycle to reserve a charge level required for the activity. In an embodiment, the real-time sensor data may be processed using one or more machine learning models 1010, trained and based on similar types of data to correctly estimate a wakeup cycle during hibernation to reserve a charge level required for the running of the vehicle. For example, comparison 1016 may be based on a loss function that measures a difference between the predicted/detected output and training data with labels 1014. Based on the comparison at 1016 or the corresponding output of the loss function, a training algorithm may update the parameters of machine learning model 1010, with the objective of minimizing the differences or loss between subsequent predicted output 1012 and the corresponding labels. By iteratively training in this manner, machine learning model 1010 may “learn” from different training data samples 1002 and become better at predicting output 1012. In an embodiment, machine learning model 1010 is trained using data which is specific to a battery type and different vehicles for which the model is used for predicting adjustments to the settings to provide accurate estimation of the wakeup cycle. In an embodiment, machine learning model 1010 is trained using data which is general to the battery types and is used for predicting adjustments for prediction of wakeup cycle. In an embodiment, the battery drain status may be given weights and provided as an input to the AI/ML system.

Through training, machine learning model 1010 may learn to identify predictive and non-predictive features and apply the appropriate weights to the features to optimize detecting and predictive accuracy of machine learning model 1010. In embodiments where supervised learning is used and each training data sample 1002 has a label, the training algorithm may iteratively process each training data sample 1002 and generate predicted output 1012. Any suitable machine learning model and training algorithm may be used, including, e.g., neural networks, decision trees, clustering algorithms, and any other suitable machine learning techniques. Once trained, machine learning model 1010 may take input data and detect the objects along with their corresponding confidence score. In an embodiment, machine learning model, 1010 is an artificial neural networks (ANN) model.

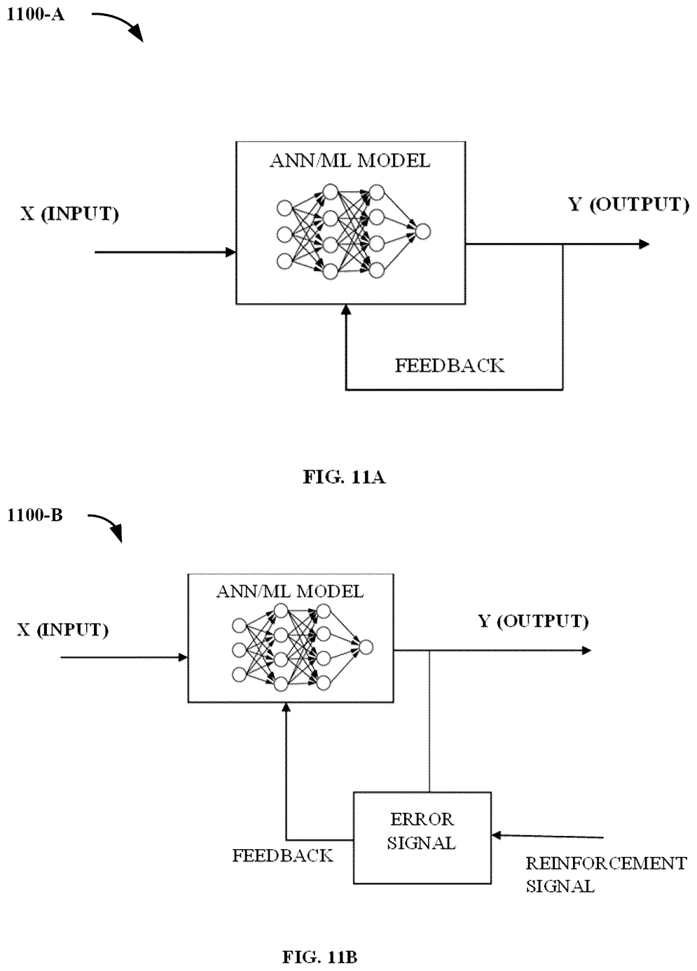

FIG. 11A shows a structure of the neural network/machine learning model with a feedback loop 1100-A according to an embodiment. Artificial neural networks (ANNs) model comprises an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed to the next layer of the network. A machine learning model or an ANN model may be trained on a set of data to take a request in the form of input data, make a prediction on that input data, and then provide a response. Input data comprises temperatire information 1004, battery status information 1006, use status and unused status of the vehicle 1008, and output data may comprise estimation of the wakeup cycle. The model may learn from the data. Learning can be supervised learning and/or unsupervised learning and may be based on different scenarios and with different datasets. Supervised learning comprises logic using at least one of a decision tree, logistic regression, and support vector machines. Unsupervised learning comprises logic using at least one of a k-means clustering, a hierarchical clustering, a hidden Markov model, and an apriori algorithm. The output layer may be prediction of a drain time and estimation of wakeup cycle based on the inputs which may be temperature information 1004, battery status information 1006, use status and unused status of the vehicle 1008.

In an embodiment, ANNs may be a Deep-Neural Network (DNN), which is a multilayer tandem neural network comprising Artificial Neural Networks (ANN), Convolution Neural Networks (CNN) and Recurrent Neural Networks (RNN) that can recognize features from inputs, do an expert review, and perform actions that require predictions, creative thinking, and analytics. In an embodiment, ANNs may be Recurrent Neural Network (RNN), which is a type of Artificial Neural Networks (ANN), which uses sequential data or time series data. Deep learning algorithms are commonly used for ordinal or temporal problems, such as language translation, Natural Language Processing (NLP), speech recognition, image recognition, etc. Like feedforward and convolutional neural networks (CNNs), recurrent neural networks utilize training data to learn. They are distinguished by their “memory” as they take information from prior input via a feedback loop to influence the current input and output. An output from the output layer in a neural network model is fed back to the model through the feedback. The variations of weights in the hidden layer(s) will be adjusted to fit the expected outputs better while training the model. This will allow the model to provide results with far fewer mistakes. The neural network is featured with the feedback loop to adjust the system output dynamically as it learns from the new data. In machine backpropagation, propagation and feedback loops are used to train an Artificial Intelligence (AI) model and continuously improve it upon usage. As the incoming data that the model receives increases, there are more opportunities for the model to learn from the data. The feedback loops, or backpropagation algorithms, identify inconsistencies and feed the corrected information back into the model as an input. Even though the AI/ML model is trained well, with large sets of labeled data and concepts, after a while the models'performance may decline while adding new, unlabeled input due to many reasons which include, but not limited to, concept drift, recall precision degradation due to drifting away from true positives, and data drift over time. A feedback loop to the model keeps the AI results accurate and ensures that the model maintains its performance and improvement, even when new unlabeled data is assimilated. A feedback loop refers to the process by which an AI model's predicted output is reused to train new versions of the model.

Initially, when the AI/ML model is trained, a few labeled samples comprising both positive and negative examples of the concepts (e.g., different types of objects, different users interacting with different objects, tracking frequency, monitoring frequency etc.) are used that are meant for the model to learn how and what adjustments needs to be performed. Afterward, the model is tested using unlabeled data. By using, for example, deep learning and neural networks, the model can then make predictions on whether the desired output (for e.g., recognition of objects and the corresponding confidence score, dynamic tracking of the object and recording last known position, a prediction of objects that the user might likely be forgetting, and the locations within the vehicle where objects when placed may be likely forgotten etc.) is in the predicted accuracy level. However, in the cases where the model returns a low probability score, this input may be sent to a controller (maybe a human moderator) which verifies and, as necessary, corrects the result. The human moderator may be used only in exceptional cases. The feedback loop feeds labeled data, auto-labeled or controller-verified, back to the model dynamically and is used as training data so that the system can improve its predictions in real-time and dynamically. These models may be utilized at various levels, for example, (i) prediction of a battery drain time and (ii) estimation of wakeup cycle.

FIG. 11B shows a structure of the neural network/machine learning model with reinforcement learning 1100-B according to an embodiment. The network receives feedback from authorized networked environments. Though the feedback logic is similar to supervised learning, the feedback obtained in this case is evaluative, not instructive, which means there is no teacher as in supervised learning. After receiving the feedback, the network performs adjustments of the weights to get better predictions in the future. Machine learning techniques, like deep learning, allow models to take labeled training data and learn to recognize those concepts in subsequent data and images. The model may be fed with new data for testing, hence by feeding the model with data it has already predicted over, the training gets reinforced. If the machine learning model has a feedback loop, for error signal, the learning is further reinforced with a reward for each true positive of the output of the system. Feedback loops ensure that AI results do not stagnate. By incorporating a feedback loop, the model output keeps improving dynamically and over usage/time.

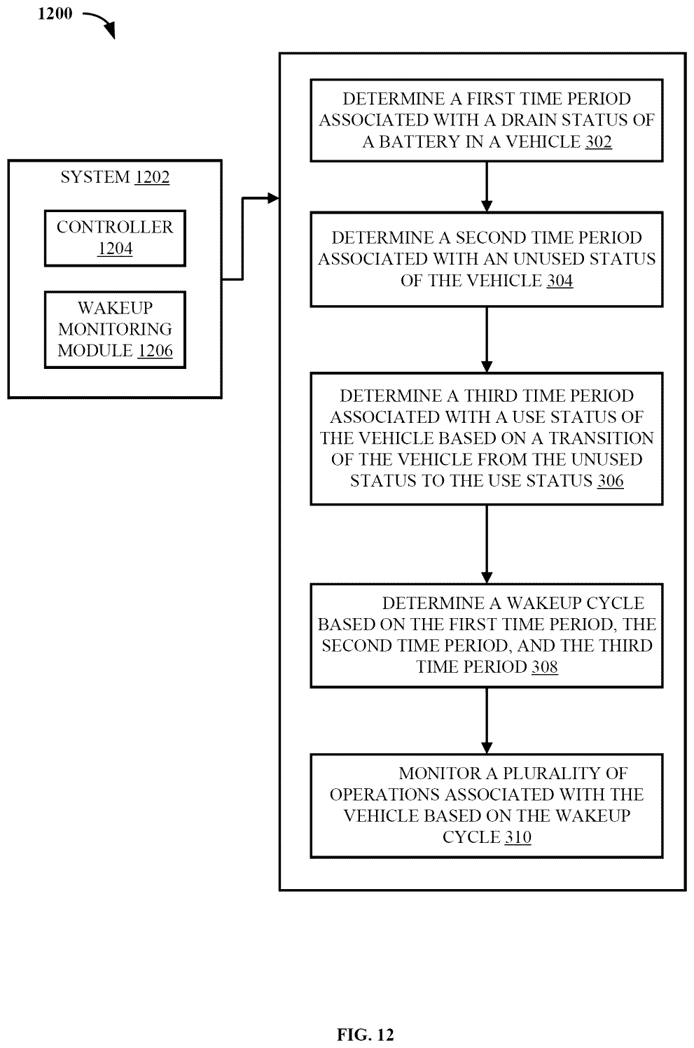

FIG. 12 shows block diagram 1200 of the system of a vehicle for managing battery power drain according to an embodiment. According to an embodiment, disclosed is system 1202 comprising controller 1204; and wakeup monitoring module 1206, wherein controller 1202 storing instructions in non-transitory memory that, when executed, cause controller 1202 to determine a first time period associated with a drain status of a battery in a vehicle 302; determine a second time period associated with an unused status of the vehicle 304; determine a third time period associated with a use status of the vehicle based on a transition of the vehicle from the unused status to the use status 306; and determine a wakeup cycle based on the first time period, the second time period, and the third time period 308, wherein the wakeup monitoring module is operable to monitor a plurality of operations associated with the vehicle based on the wakeup cycle 310.

In some embodiments, the instructions further cause controller 1202 to compare the first time period with the second time period; and modify the wakeup cycle to reserve a battery charge level for servicing an activity associated with the third time period based on the second time period greater than the first time period.

In some embodiments, the instructions further cause controller 1202 to determine the reserved battery charge level is able to service the activity associated with the third time period; and assign a priority level to the plurality of operations based on the reserved battery charge level failing to service the activity associated with the third time period.

In some embodiments, the instructions further cause controller 1202 to determine an update associated with the drain status of the battery; update the first time period based on the updated drain status of the battery; and modify the wakeup cycle based on the updated first time period.

In some embodiments, the instructions further cause controller 1202 to determine a change in the monitored temperature; and modify the wakeup cycle based on the change in the monitored temperature.

In some embodiments, the instructions further cause controller 1202 to perform at least one of: receive a manual input associated with the unused status and the use status of the vehicle; and detect the unused status and the use status of the vehicle based on at least one of a schedule information, a calendar information, and a preset pattern associated with a user of the vehicle.

In some embodiments, the instructions further cause controller 1202 to determine an update associated with at least one of the unused status and the used status of the vehicle; determine a modification associated with at least one of the second time period, and the third time period based on an updated unused status and an updated use status, respectively; and modify the wakeup cycle based on at least one of a modified second time period and a modified third time period.

In some embodiments, the instructions further cause controller 1202 to determine a reserved battery charge level is able to service an activity associated with the modified third time period; and assign a priority level to the plurality of operations based on the reserved battery charge level failing to service the activity associated with the modified third time period.

In some embodiments, the instructions further cause controller 1202 to monitor the plurality of operations associated with the vehicle based on the assigned priority level and the modified wakeup cycle; determine the reserved battery charge level is able to service the activity associated with the modified third time period based on the assigned priority level; and generate an alert message to the user of the vehicle based on the reserved battery charge level failing to service the activity associated with the modified third time period.

In some embodiments, the instructions further cause controller 1202 to schedule, automatically, a battery recharge operation based on the reserved battery charge level failing to service the activity associated with the modified third time period.

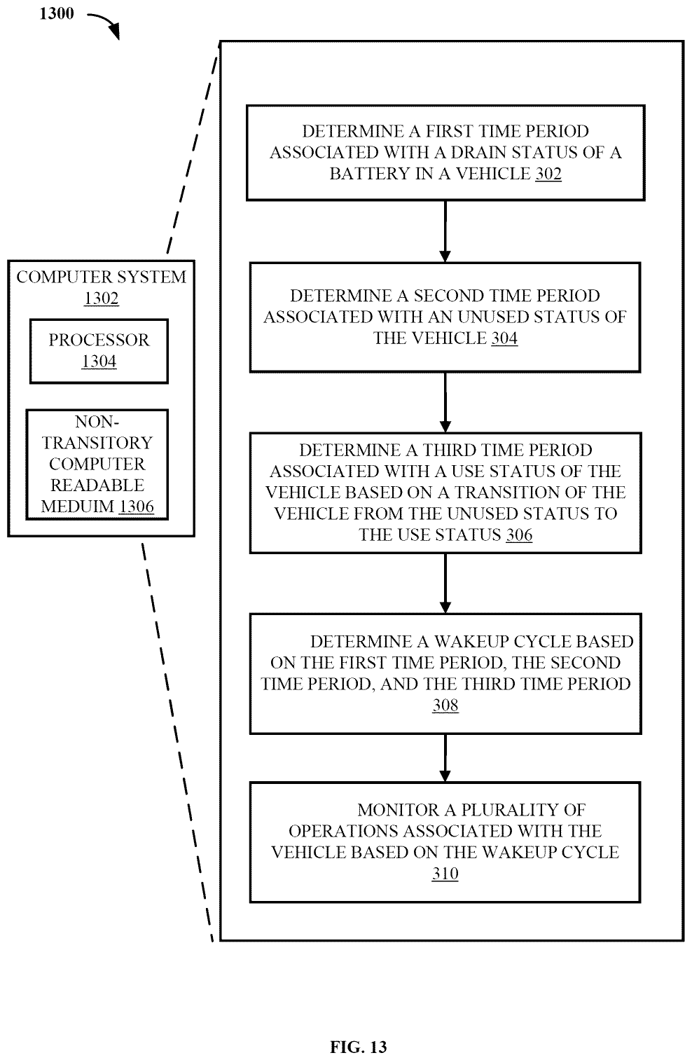

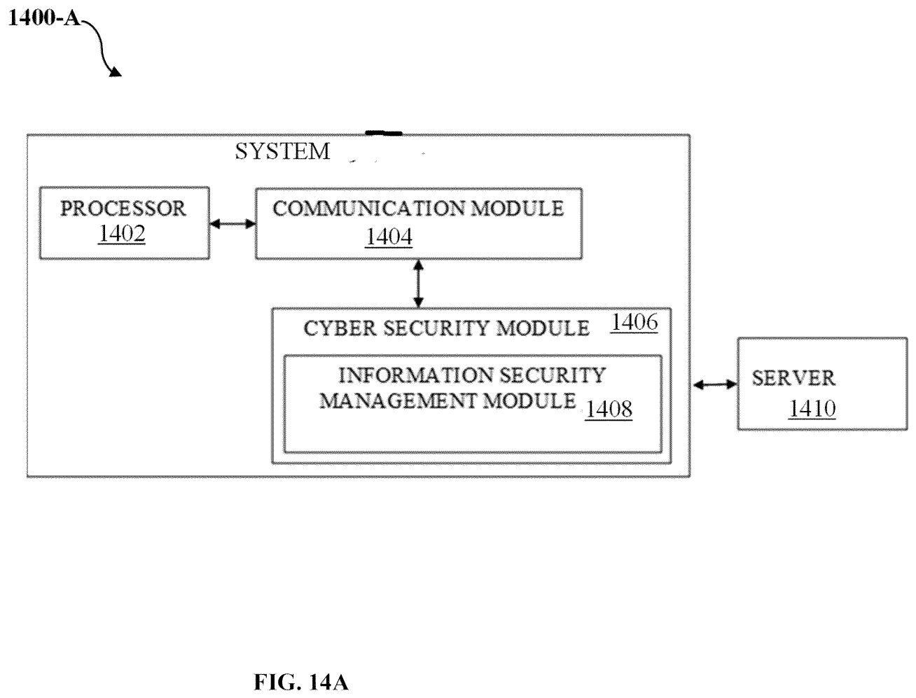

FIG. 13 shows block diagram 1300 of the method executed by the non-transitory computer-readable medium for battery power drain managing system according to an embodiment.

According to an embodiment, disclosed is non-transitory computer-readable storage medium 1306 having stored thereon instructions executable by computer system 1302 to perform operations comprising determining a first time period associated with a drain status of a battery in a vehicle 302; determining a second time period associated with an unused status of the vehicle 304; determining a third time period associated with a use status of the vehicle based on a transition of the vehicle from the unused status to the use status 306; determining a wakeup cycle based on the first time period, the second time period, and the third time period 308; and monitoring a plurality of operations associated with the vehicle based on the wakeup cycle 310. A software application may be stored on computer-readable medium 1306 and executed by processor 1304 of computer system 1302.

In some embodiments, non-transitory computer-readable medium 1306 further comprises instructions to perform operations comprising: comparing the first time period with the second time period; and modifying the wakeup cycle to reserve a battery charge level for servicing an activity associated with the third time period based on the second time period greater than the first time period.

In some embodiments, non-transitory computer-readable medium 1306 further comprises instructions to perform operations comprising: determining the reserved battery charge level is able to service the activity associated with the third time period; and assigning a priority level to the plurality of operations based on the reserved battery charge level failing to service the activity associated with the third time period.

In some embodiments, non-transitory computer-readable medium 1306 further comprises instructions to perform operations comprising: determining a change in at least one monitored operation of the plurality of monitored operations; and modifying the wakeup cycle based on the change in the at least one monitored operation.

In some embodiments, non-transitory computer-readable medium 1306 further comprises instructions to perform operations comprising: determining an update associated with the drain status of the battery; updating the first time period based on the updated drain status of the battery; and modifying the wakeup cycle based on the updated first time period.

In some embodiments, non-transitory computer-readable medium 1306 further comprises instructions to perform operations comprising: determining a change in the monitored temperature; and modifying the wakeup cycle based on the change in the monitored temperature.

In some embodiments, non-transitory computer-readable medium 1306 further comprises instructions to perform operations comprising: receiving a manual input associated with the unused status and the use status of the vehicle; and detecting the unused status and the use status of the vehicle based on at least one of a schedule information, a calendar information, and a preset pattern associated with a user of the vehicle.

In some embodiments, non-transitory computer-readable medium 1306 further comprises instructions to perform operations comprising: determining an update associated with at least one of the unused status and the used status of the vehicle; determining a modification associated with at least one of the second time period and the third time period based on an updated unused status and an updated use status, respectively; and modifying the wakeup cycle based on at least one of a modified second time period and a modified third time period.

In some embodiments, non-transitory computer-readable medium 1306 further comprises instructions to perform operations comprising: determining a reserved battery charge level is able to service an activity associated with the modified third time period; and assigning a priority level to the plurality of operations based on the reserved battery charge level failing to service the activity associated with the modified third time period.

In some embodiments, non-transitory computer-readable medium 1306 further comprises instructions to perform operations comprising: monitoring the plurality of operations associated with the vehicle based on the assigned priority level and the modified wakeup cycle; determining the reserved battery charge level is able to service the activity associated with the modified third time period; and generating an alert message to the user of the vehicle based on the reserved battery charge level failing to service the activity associated with the modified third time period.

In some embodiments, non-transitory computer-readable medium 1306 further comprises instructions to perform operations comprising: scheduling an automatic battery recharge operation based on the reserved battery charge level failing to service the activity associated with the modified third time period.

FIG. 14A shows a block diagram of a cyber security module 1400-A in view of the system and server according to an embodiment.

Referring to FIG. 14A, a system comprising processor 1402, communication module 1404, cyber security module 1406, and information security management module 1408 in communication with server 1410, is shown. The communication of data between the system and server 1410 through communication module 1404 is first verified by information security management module 1408 before being transmitted from the system to server 1410 or from server 1410 to the system. Information security management module 1408 is operable to analyze the data for potential cyber security threats, to encrypt the data when no cyber security threat is detected, and to transmit the data encrypted to the system or server 1410.

FIG. 14B shows an embodiment of the cyber security module, in accordance with some embodiments of the present disclosure.

Referring to FIG. 14B, a method 1400-B for securing the data through cyber security module 1406 is shown. At step 1412, the information security management module is operable to receive data from the communication module. At step 1414, the information security management module exchanges a security key at a start of the communication between the communication module and the server. At step 1416, the information security management module receives a security key from the server. At step 1418, the information security management module authenticates an identity of the server by verifying the security key. At step 1420, the information security management module analyzes the security key for potential cyber security threats. At step 1422, the information security management module negotiates an encryption key between the communication module and the server. At step 1424, the information security management module receives the encrypted data. At step 1426, the information security management module transmits the encrypted data to the server when no cyber security threat is detected.

FIG. 14C shows another embodiment of the cyber security module, in accordance with some embodiments of the present disclosure.

Referring to FIG. 14C, a method 1400-C for securing the data through the cyber security module is shown. At step 1428, the information security management module is operable to: exchange a security key at a start of the communication between the communication module and the server. At step 1430, the information security management module receives a security key from the server. At step 1432, the information security management module authenticates an identity of the server by verifying the security key. At step 1434, the information security management module analyzes the security key for potential cyber security threats. At step 1436, the information security management module negotiates an encryption key between the communication module and the server. At step 1438, the information security management module receives encrypted data. At step 1440, the information security management module decrypts the encrypted data, and performs an integrity check of the decrypted data. At step 1442, the information security management module transmits the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server. In an embodiment, the information security management module is configured to raise an alarm if a cyber security threat is detected. In an embodiment, the information security management module is configured to discard the encrypted data received if the integrity check of the encrypted data fails. In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 14A, identity authentication is first carried out on the system and the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature. In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine. In an embodiment, both communication parties need to authenticate their own identities through a pair of asymmetric keys, and a task in charge of communication with the information security management module of the system is identified by a unique pair of asymmetric keys. In an embodiment, the dynamic negotiation key is encrypted by adopting an Rivest-Shamir-Adleman (RSA) encryption algorithm. RSA is a public-key cryptosystem that is widely used for secure data transmission. The negotiated keys include a data encryption key and a data integrity check key. In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

In some embodiments, the communication between vehicle 902 and server 904 as shown in FIG. 9 may be secured by the cyber security module. Vehicle 902 may include the communication module coupled to the information security management module, The communication of battery charge level, use status, and the unused status between the vehicle and the server through the communication module may be first verified by the information security management module before being transmitted from the vehicle to the server or from the server to the vehicle. The information security management module is operable to analyze the data for potential cyber security threats, to encrypt the data when no cyber security threat is detected, and to transmit the data encrypted to the vehicle or the server.

In an embodiment, the communication module may be communicatively coupled to the controller and operable to transmit, securely, at least one of use status, unused status, and a change in at least one of the plurality of operations being monitored to a server; and receive the action plan from the server, wherein the action plan comprises at least one of wakeup cycle modification, alert generation, battery recharge scheduling, and distress signal scheduling.

How Technical Solution is a Technological Advancement:
a) An adaptive wakeup cycle estimation enables conserving a battery power required by the vehicle to perform one or more activities upon restarting the vehicle from the hibernation mode.
b) The present disclosure discusses the wakeup cycle estimation based on a time taken for the vehicle battery to get completely drained, the time duration the vehicle is in the idle condition, and also the time duration for which the vehicle is anticipated to be working after the vehicle is restarted. Considering all three aspects enables a more accurate estimation of the wakeup cycle.
c) The present disclosure further discusses assigning a priority level to one or more operations that are being monitored during the hibernation mode. This provides an advantage of monitoring the activities that are crucial for the performance of the vehicle and at the same time enables conserving the required battery power for the anticipated use.
d) The present disclosure discusses provisioning of alert message, automatic battery recharge scheduling, and distress signal scheduling, enabling a more user-friendly situation when the battery is completely drained.

The descriptions of the one or more embodiments are for purposes of illustration but are not exhaustive or limiting to the embodiments described herein. Many modifications and variations will be apparent to those of ordinary skill in the art without departing from the scope and spirit of the described embodiments. The terminology used herein best explains the principles of the embodiments, the practical application and/or technical improvement over technologies found in the marketplace, and/or to enable others of ordinary skill in the art to understand the embodiments described herein.

1-54. (canceled)

55. A system comprising:
a wakeup monitoring module; and
a controller communicatively coupled to the wakeup monitoring module, wherein the controller is operable to:
determine a first time period associated with a drain status of a battery in a vehicle;
determine a second time period associated with an unused status of the vehicle;
determine a third time period associated with a use status of the vehicle based on a transition of the vehicle from the unused status to the use status; and
determine a wakeup cycle based on the first time period, the second time period, and the third time period,
wherein the wakeup monitoring module is operable to monitor a plurality of operations associated with the vehicle based on the wakeup cycle.

56. The system of claim 55, wherein the controller is further operable to:
compare the first time period with the second time period; and
modify the wakeup cycle to reserve a battery charge level for servicing an activity associated with the third time period based on the second time period greater than the first time period.

57. The system of claim 56, wherein the controller is further operable to:
determine the reserved battery charge level is able to service the activity associated with the third time period; and
assign a priority level to the plurality of operations based on the reserved battery charge level failing to service the activity associated with the third time period.

58. The system of claim 55, wherein the drain status of the battery comprises a decrease in an initial charge level of the battery.

59. The system of claim 58, wherein the first time period comprises a time taken for the initial charge level of the battery to reduce to a zero charge level and the initial charge level comprises a charge level of the battery based on the vehicle entering the unused status.

60. The system of claim 55, wherein the unused status of the vehicle comprises the vehicle in an ignition OFF condition and the second time period comprises a time duration of the vehicle in the ignition OFF condition.

61. The system of claim 55, wherein the transition of the vehicle from the unused status to the use status comprises the vehicle in an ignition ON condition and the third time period comprises a time duration associated with an activity of the vehicle based on the ignition ON condition.

62. The system of claim 55, wherein the plurality of operations comprises at least one of:
monitoring activities associated with vehicle security systems, determining the drain status of the battery, detecting a keyless entry, detecting a remote start, monitoring an alarm system, fault diagnosis, monitoring the operation of a telematics system, monitoring condition of passive safety systems, monitoring temperature associated with an environment of the vehicle, climate control operations, and monitoring tire pressure.

63. The system of claim 62, wherein the controller is further operable to:
determine an update associated with the drain status of the battery;
update the first time period based on the updated drain status of the battery; and
modify the wakeup cycle based on the updated first time period.

64. The system of claim 62, wherein the controller is further operable to:
determine a change in the monitored temperature; and
modify the wakeup cycle based on the change in the monitored temperature.

65. The system of claim 55, wherein the controller is further operable to perform at least one of:
receive a manual input associated with the unused status and the use status of the vehicle; and
detect the unused status and the use status of the vehicle based on at least one of a schedule information, a calendar information, and a preset pattern associated with a user of the vehicle.

66. The system of claim 65, wherein the controller is further operable to:
determine an update associated with at least one of the unused status and the used status of the vehicle;
determine a modification associated with at least one of the second time period, and the third time period based on an updated unused status and an updated use status, respectively; and
modify the wakeup cycle based on at least one of a modified second time period and a modified third time period.

67. The system of claim 66, wherein the controller is further operable to:
determine a reserved battery charge level is able to service an activity associated with the modified third time period;
assign a priority level to the plurality of operations based on the reserved battery charge level failing to service the activity associated with the modified third time period;
monitor the plurality of operations associated with the vehicle based on the assigned priority level;
determine the reserved battery charge level is able to service the activity associated with the modified third time period based on the assigned priority level; and
generate an alert message to the user of the vehicle based on the reserved battery charge level failing to service the activity associated with the modified third time period.

68. The system of claim 67, wherein the controller is further operable to:
schedule, automatically, a battery recharge operation based on the reserved battery charge level failing to service the activity associated with the modified third time period.

69. A method comprising:
determining, by a controller, a first time period associated with a drain status of a battery in a vehicle;
determining, by the controller, a second time period associated with an unused status of the vehicle;
determining, by the controller, a third time period associated with a use status of the vehicle based on a transition of the vehicle from the unused status to the use status;
determining, by the controller, a wakeup cycle based on the first time period, the second time period, and the third time period; and
monitoring, by a wakeup monitoring module, a plurality of operations associated with the vehicle based on the wakeup cycle.

70. The method of claim 69 further comprising:
comparing, by the controller, the first time period with the second time period;
modifying, by the controller, the wakeup cycle to reserve a battery charge level for servicing an activity associated with the third time period based on the second time period greater than the first time period;
determining, by the controller, the reserved battery charge level is able to service the activity associated with the third time period; and
assigning, by the controller, a priority level to the plurality of operations based on the reserved battery charge level failing to service the activity associated with the third time period.

71. The method of claim 69 further comprising:
determining, by the controller, a change in at least one monitored operation of the plurality of monitored operations;
determining, by the controller, a modification associated with at least one of the second time period and the third time period; and
modifying, by the controller, the wakeup cycle based on at least one of: change in the at least one monitored operation, a modified second time period, and a modified third time period.

72. The method of claim 71 further comprising:
monitoring, by the controller, the plurality of operations associated with the vehicle based on the modified wakeup cycle;
determining, by the controller, a reserved battery charge level is able to service an activity associated with the modified third time period; and
assigning, by the controller, a priority level to the plurality of operations based on the reserved battery charge level failing to service the activity associated with the modified third time period;
monitoring, by the controller, the plurality of operations associated with the vehicle based on the assigned priority level;
determining, by the controller, the reserved battery charge level is able to service the activity associated with the modified third time period based on the assigned priority level; and
generating, by the controller, an alert message to a user of the vehicle based on the reserved battery charge level failing to service the activity associated with the modified third time period.

73. The method of claim 72 further comprising:
scheduling, by the controller, an automatic battery recharge operation based on the reserved battery charge level failing to service the activity associated with the modified third time period.

74. A non-transitory computer-readable medium having stored thereon instructions executable by a computer system to perform operations comprising:
determining a first time period associated with a drain status of a battery in a vehicle;
determining a second time period associated with an unused status of the vehicle;
determining a third time period associated with a use status of the vehicle based on a transition of the vehicle from the unused status to the use status;
determining a wakeup cycle based on the first time period, the second time period, and the third time period; and
monitoring a plurality of operations associated with the vehicle based on the wakeup cycle.
